(19) United States
(12) Patent Application Publication
(10) Pub. No.: US 2026/0068888 A1
(43) Pub. Date: Mar. 12, 2026

(54) ALGICIDAL FOAM COMPOSITIONS AND METHODS OF MAKING AND USING THEREOF

(71) Applicants: THE ADMINISTRATORS OF THE TULANE EDUCATIONAL FUND, New Orleans, LA (US); UNIVERSITY OF MARYLAND, COLLEGE PARK, College Park, MD (US); MOTE MARINE LABORATORY, Sarasota, FL (US)

(72) Inventors: Vijay JOHN, New Orleans, LA (US); Srinivasa R. RAGHAVAN, College Park, MD (US); Vincent LOVKO, Sarasota, FL (US); Faraz A. BURNI, College Park, MD (US); Wei-Yi CHU, College Park, MD (US)

(21) Appl. No.: 19/381,801

(22) Filed: Nov. 6, 2025

Related U.S. Application Data
(63) Continuation of application No. PCT/US2025/026237, filed on Apr. 24, 2025.
(60) Provisional application No. 63/638,229, filed on Apr. 24, 2024.
(60) Provisional application No. 63/712,457, filed on Oct. 26, 2024.

(51) Int. Cl. A01N 59/00; A01N 25/16; A01N 25/30; A01N 37/40; A01N 39/00; A01N 43/90; A01P 13/00

(52) U.S. Cl. CPC A01N 59/00; A01N 25/16; A01N 25/30; A01N 37/40; A01N 39/00; A01N 43/90; A01P 13/00

(57) ABSTRACT

Described herein are aqueous-based foams for use in controlling algal blooms.

### CROSS-REFERENCE TO RELATED APPLICATIONS

This application claims benefit of priority of U.S. Provisional Application 63/638,229, filed Apr. 24, 2025, and U.S. Provisional Application 63/712,457, filed Oct. 26, 2024, each of which is hereby incorporated by reference in its entirely.

### BACKGROUND

The occurrence of harmful algal blooms (HABs) poses significant challenges to coastal communities and economies worldwide. Under favorable conditions, the growth rate of a dominant phytoplankton species can increase, leading to a large rise in its biomass within a body of water, referred to as a bloom. The intensification of HABs, in particular those that cover large areas, is a matter of growing concern to the public, water authorities, and environmental scientists worldwide. The formation of various toxins by these organisms constitutes a serious threat to the water quality in lakes and reservoirs and their use for drinking water, recreational activities, and irrigation. Further, the approaches currently used to limit toxic blooms, such as management of the drainage basin (e.g., to reduce nutrient inputs), are expensive and unsuccessful.

Approximately 300 phytoplankton species-cyanobacteria (often called blue-green algae) such as Microcystis sp. (e.g., Microcystis aeruginosa) and microalgae are known to form massive blooms, many of them producing an array of toxic chemicals. Due to massive O₂ consumption in respiration, the blooms may cause depletion of O₂ and massive death of fish and fauna, and clogging of the water pumps and filters. The annual global losses associated with these blooms is estimated at many billions of USD.

For example, the “red tide” caused by the toxic dinoflagellate species Karenia brevis (KB) is observed annually during periods of eutrophication and is especially prevalent in waters along the coastlines of the Gulf of Mexico. The severity of such HAB occurrences has increased dramatically over the last few decades. Karenia brevis is a marine dinoflagellate that produces brevetoxins that cause significant mortalities to fish and other marine life. Such toxins have also been found in marine aerosols and cause respiratory illnesses in humans living in coastal communities together with economic impacts on the tourism industry.

Cyanobacteria are photo synthetic (gram-negative) bacteria. Many cyanobacterial species produce and thereafter release toxins (a.k.a. “cyanotoxins”) into the water either towards the end of the bloom or under physical duress (e.g., during filtration or pumping). Studies showed that cyanotoxins cause death and various illnesses in humans and animals who drink, swim or even consume food that was exposed to infested water. The cyanotoxins are not sensitive to boiling, and can only be treated to allow for drinking with heavy chlorination. The WHO recommends prohibiting consumption of, or recreation in, water where toxic cyanobacterial biomass exceeds 10 mg/l chlorophyll a and may reach levels as high as 1100 mg/l chlorophyll a. Further, cyanobacterial blooms excrete massive amounts of polysaccharides into the water, turning it viscous. This phenomenon is sometimes also related to “swimmers' itch”-due to the itch caused when coming in contact with contaminated water. It further creates operational problems for water utility companies that face regularly clogged pipes as well as for farmers preventing them from using drip-irrigation systems.

Microalgae are a diverse group of eukaryotic photosynthetic microorganisms that includes several groups including green-algae, red algae, brown algae, diatoms and dinoflagellates. They are responsible for clogged pipes in reservoirs used for irrigation or sewage ponds. Some algal species (e.g., Prymnesium sp., Karenia sp., Alexandrium sp., and others) are toxic as well and are responsible for mass fish-mortality in aquaculture and marine environments. Illnesses and even deaths are occasionally reported among people and animals that consumed toxic water or seafood contaminated with algal toxins.

Most phytoplankton blooms are treated worldwide with copper salts such as copper sulfate pentahydrate (CuSO₄-5H₂0), an algicide that causes algal lysis. However, in water with high organic load, mineral content or PH levels above pH 7.0, its efficacy is reduced dramatically. Further, environmental concerns limit the use of copper salts in many jurisdictions.

Alternative algicide formulations incorporate the use of hydrogen peroxide (H₂O₂), either via direct application or its release from various compounds such as percarbonates. Cyanobacteria are far more sensitive to H₂O₂ than most microalgae. Thus, H₂O₂ treatments damage toxic cyanobacteria while far less affecting other algae. The mode of action of H₂O₂ involves the triggering of oxidative stress. Thereby it may prompt an autocatalytic cell-death cascade among the phytoplankton population. Currently used protocols to treat Microcystis sp. blooms with H₂O₂ generally rely on a single treatment of H₂O₂ as high as of 0.7-1 mM.

While many treatment strategies have been explored, existing algicide applications currently suffer from a variety of shortcomings, including the need to administer high concentrations of algicides (with attendant environmental impact) and difficulty administering algicidal compositions to effectively treat blooms. The compositions and methods described herein address these and other needs.

### SUMMARY

Described herein are aqueous foam precursor compositions that comprise a foam-forming agent; an algicide; and water.

Also described herein are aqueous foam precursor compositions that comprise a foam-forming agent; a flocculant comprising a metal phenolic network (MPN); and water.

Also provided herein are foamable compositions comprising an aqueous foam precursor composition described herein and a liquefied or a compressed gas propellant. The foamable composition can be provided in a sealed canister, allowing for convenient deployment of the aqueous-based foams described herein.

Also described herein are aqueous-based foams comprising an aqueous foam precursor composition described herein and an expansion gas (e.g., entrained therewithin).

Also provided herein are methods for mitigating, inhibiting, and/or eliminating phytoplankton growth in a waterbody. These methods can comprise applying an aqueous-based foam described herein to the waterbody (e.g., to a portion of the waterbody where a phytoplankton bloom is present).

Additional advantages of the disclosed compositions, systems, and methods will be set forth in part in the description which follows, and in part will be obvious from the description. The advantages of the disclosed compositions, systems, and methods will be realized and attained by means of the elements and combinations particularly pointed out in the appended claims. It is to be understood that both the foregoing general description and the following detailed description are exemplary and explanatory only and are not restrictive of the disclosed compositions, systems, and methods, as claimed.

The details of one of more embodiments of the invention are set forth in the accompanying drawings and description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Schematic of Algicide delivery through a foam. The flow of algaecides/flocculants is shown with the arrows pointing downwards. Viable cells are shown in the water column, and the dead cells are shown at the bottom. The inset on top right shows a schematic of the foam microstructure, with the liquid microchannels shown between the air bubbles shown in white. The inset in the bottom right shows a more detailed schematic of the microstructure of a foam showing the potential of loading multiple algaecides and flocculation agents. The surfactant stabilizes the air-water interface of the bubbles but also exists as micelles in the microaqueous phase

FIGS. 2A-2C. (FIG. 2A) Optical image of 10 mg/mL (1 wt %) Tween-80 foam; (FIG. 2B) a micrograph of a foam generated from 10 mg/mL (1 wt %) Tween-80 stock solution (scale bar 200 μm). The inset shows a schematic of the microstructure; (FIG. 2C) plot showing the size distribution of bubbles.

FIG. 3. Plot showing the effect of Tween-80 concentration in foams on the viability of Karenia brevis cells at 0.125, 0.25, and 0.5 wt % Tween-80.

FIG. 4. Schematic illustration of the mechanism for the generation of H₂O₂ from a polyphenolic compound in basic environments. In some embodiments, R in these structures represents a carboxylate moiety. The theoretical capacity of producing two moles of H₂O₂ from the oxidation of one mole of gallic acid.

FIGS. 5A-5B. (FIG. 5A) a schematic of the microstructure of foams loaded with gallic acid, a water-soluble algicide; (FIG. 5B) effect of applying foams loaded with gallic acid on cell viability at 6, 24, and 48 hours after treatment. Tween 80 concentration in the foam was 1.25 mg/mL (0.125 wt %).

FIG. 6. Algaecidal effect of gallic acid (GA) in the foam. SYTOX-green fluorescent micrographs of cells treated with GA loaded in the foam at 3, 6, and 24 hours, respectively. Non-viable cells become lysed by 6 hours of treatment resulting in a loss of the green fluorescence. Viable cells retain the red fluorescence over the time duration of the experiment. The Tween 80 concentration in foams was 1.25 mg/mL (0.125 wt %). All scale bars are 100 μm. Gallic acid concentration in the foam stock solution is 5 mg/mL.

FIGS. 7A-7C. (FIG. 7A) a schematic of the microstructure of foams loaded with CaO₂. (FIG. 7B) a micrograph of bubbles and calcium peroxide particles within the foam (scale bar 200 μm). The inset shows a single bubble indicating particles at the bubble-water interface. (FIG. 7C) the effect of applying foams loaded with calcium peroxide on the viability of cells at 6, 24, and 48 hours after treatment. The Tween 80 concentration in the foam was 1.25 mg/mL (0.125 wt %).

FIGS. 8A-8E. Formation of flocs with PAC initially loaded into the foam and accelerated settling of the flocs with kaolinite also loaded in the foams. (FIG. 8A) schematic of foam microstructure with PAC in the microaqueous phase. (FIG. 8B), (FIG. 8C), (FIG. 8D) and (FIG. 8E) refer to photographic images of PAC and clay delivery from the foam at 0, 1 hr, 3 hrs and 24 hrs respectively. A, B, C, D indicate kaolinite loadings of 0, 0.7, 1.3, 2.7 mg/mL in the foam. All vials had a loading of PAC of 5.33 mg/L in the foam. Tween-80 concentration in the foam was 1.25 mg/mL (0.125 wt %).

FIGS. 9A-9B. Flocculation of KB cells through incorporation of PAC inside foams: (FIG. 9A) cell density in suspension after flocculation with PAC; (FIG. 9B) optical micrograph (scale bar 200 μm) of cells trapped in a PAC floc where the PAC was delivered through the foam. The inset is a photograph of a floc containing the trapped cells. Tween 80 concentration in the foam was 1.25 mg/mL (0.125 wt %).

FIGS. 10A-10B. Flocculation and destruction of KB cells through delivery of PAC and CaO₂ from foams. (FIG. 10A) effect of applying foams loaded with PAC and CaO₂ on cell density in suspension with virtually complete removal observed. (FIG. 10B) SYTOX™-green fluorescent micrographs of cells in the floc after treatment. The blurring of fluorescence is due to imaging through the floc and the high concentration of non-viable cells. Scale bar 100 μm.

FIG. 11. Structure of tannic acid.

FIG. 12. Structure of chitosan.

FIG. 13. Tannic acid glues liposomes to form flocculated vesicles without impacting vesicle morphology.

FIGS. 14A-14C. Illustration of the structural components of metal-phenolic networks (MPNs) as well as their interaction.

FIG. 15. MPN complexes with CS flocculate KB efficiently.

FIG. 16. The flocculation of MC using TA and CS. The top row shows imaging through optical microscopy while the bottom row shows imaging through cryogenic SEM. The left column is the control with just MC, the center column represents flocculation with TA and CS and the right column represents large flocs formed with MPNs and CS (MPN-CS). Connecting strands between cells are clearly shown in the cryo-SEMs. The inset photographs show the flocculated samples and the lack of flocculation in the control sample.

FIGS. 17A-17B. Further illustration of the structural components of metal-phenolic networks (MPNs) as well as their interaction. FIG. 17A illustrates the mechanism of MPN formation through coordination of Fe (III) or Mg(II) to TA. FIG. 17B illustrates the highly extended networks formed by MPNs linked through CS strands to form MPN-CS complexes.

FIG. 18. Illustrates enhancing CS water solubility at freshwater pH values.

### DETAILED DESCRIPTION

The compositions, systems, and methods described herein may be understood more readily by reference to the following detailed description of specific aspects of the disclosed subject matter and the Examples included herein.

### Definitions

Before the present compositions, systems, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Unless otherwise defined, all technical and scientific terms used herein have the same meaning as commonly understood by one of ordinary skill in the art to which this invention belongs. Unless otherwise specified, all percentages are in weight percent and the pressure is in atmospheres.

The organic moieties mentioned when defining variable positions within the general formulae described herein (e.g., the term “halogen”) are collective terms for the individual substituents encompassed by the organic moiety. The prefix Cₙ-Cₘ preceding a group or moiety indicates, in each case, the possible number of carbon atoms in the group or moiety that follows.

References in the specification and concluding claims to parts by weight of a particular element or component in a composition denotes the weight relationship between the element or component and any other elements or components in the composition or article for which a part by weight is expressed at room temperature (e.g., ˜20° C.) and pressure (1 atm). Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included at room temperature (e.g., ˜20° C.) and pressure (1 atm).

Also, throughout this specification, various publications are referenced. The disclosures of these publications in their entireties are hereby incorporated by reference into this application in order to more fully describe the state of the art to which the disclosed subject matter pertains. The references disclosed are also individually and specifically incorporated by reference herein for the material contained in them that is discussed in the sentence in which the reference is relied upon.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

In this specification and in the claims that follow, reference will be made to a number of terms, which shall be defined to have the following meanings.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of +10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) can includes 10% and also includes 20%, and includes percentages in between 10% and 20%, unless explicitly stated otherwise herein.

“Exemplary” means “an example of” and is not intended to convey an indication of a preferred or ideal embodiment. “Such as” is not used in a restrictive sense, but for explanatory purposes.

“Optional” or “optionally” means that the subsequently described event or circumstance occurs and instances where it does not.

The term “phytoplankton” as used herein refers to a microorganism that performs photosynthesis in an aquatic environment. The two major groups of phytoplankton are: (1) cyanobacteria (also referred to as “Blue-green Algae”) and (2) microalgae (i.e., eukaryotic photosynthetic microorganisms).

Non-limiting examples of cyanobacterial species include: Microcystis sp., Nodularia sp., Cylindrospermopsis sp., Lyngbya sp., Planktothrix sp., Oscillatoria sp., Schizothrix sp., Anabaena sp., Pseudanabaena sp., Aphanizomenon sp., Umezakia sp., Nostoc sp., and Spirulina sp. Their known cyanotoxins include: microcystins, nodularins, anatoxin, cylindrospermopsins, lyngbyatoxin, saxitoxin, and lipopolysaccharides.

Non-limiting examples of algae include: Karenia sp., Gymnodinium sp., dinoflagellates, and Prymnesium sp. (also referred to as golden algae). Their list of toxins includes paralytic shellfish toxin (PST), aplysiatoxins, β-Methylamino-L-alanine (BMAA), brevetoxins, and ptychodiscus.

As used herein, the term “non-toxic algae” refers to algae which do not produce toxins of a kind or at a concentration hazardous to the ecosystem of the water system. According to some embodiments, non-toxic algae do not produce paralytic shellfish toxin (PST), aplysiatoxins, β-Methylamino-L-alanine (BMAA), brevetoxins, and ptychodiscus.

As used herein, the term “non-toxic cyanobacteria” refers to cyanobacteria, which do not produce toxins of a kind or at a concentration hazardous to the ecosystem of the water system. According to some embodiments, non-toxic cyanobacteria do not produce microcystis, nodularins, anatoxin, cylindrospermopsins, lyngbyatoxin, saxitoxin, and lipopolysaccharides.

As used herein, the term “Phytoplankton Blooms” refers to a population explosion of phytoplankton in waterbodies. The phenomenon is identified when large quantities of buoyant photosynthetic micro-organisms float at the photic depth (where light intensity is higher than 1% that of the surface water) or on the water surface. It refers to the phenomenon when cyanobacteria or microalgae species multiply their biomass in a logarithmic manner over a period of one day, a week, two-weeks, a month, and/or a season.

The terms “algicide” or “algaecide” as used herein refers to compounds capable of exterminating, lysing, killing, inhibiting growth of, inhibiting proliferation of, inhibiting photosynthesis or otherwise reducing/preventing/inhibiting/treating/mitigating phytoplankton infestation. Non-limiting examples of suitable algicides include oxidizers (e.g. hypochlorite, H₂O₂ or H₂O₂ producing chemicals such as sodium percarbonate), phosphate chelating agents (e.g. alum-salts, bentonite clay), copper-based compounds, potassium permanganate and combinations thereof. According to some embodiments, the algicide may include a combination of algicides, such as, but not limited to, H₂O₂ and copper-based algicides, which combination may have a synergistic effect, thus enabling reducing the overall usage of chemicals.

The term “waterbody” as used herein refers to any type of reservoir, aquaculture, basin, salt or fresh or brine waters, ocean, gulf, sea, stagnant water, estuary, pond, lake, canal, or river, whether natural or manmade.

In some embodiments, the term “mitigation” as used herein refers to reducing phytoplankton biomass by 90%, 80%, 70%, 60%, 50% or more within 30 min, 90 min, 6 hours, 1 day, 2 days, or one week, from treatment application. Each possibility is a separate embodiment.

The term “periodic treatment” as used herein refers to a treatment every 24 hours, 2 days, a week, every 2-4 weeks, once a month, once every 2 months, once a quarter, once a year, or twice a year. Each possibility is a separate embodiment. According to some embodiments, the periodic treatment may be seasonal treatment.

The term “infected area” as used herein refers to an area that is contaminated with phytoplankton biomass such that (1) the concentration of chlorophyll-a (mass/vol) is about 10 mg/L or more; (2) the concentration of phytoplankton cells (#/vol) is greater than about 20,000 phytoplankton cells/mL, or (3) a combination thereof. The area can be defined using probes or standard-laboratory extraction methods to detect photosynthetic pigments (that capture the light energy necessary for photosynthesis) as a proxy of specific phytoplankton species such as: chlorophyll-a, chlorophyll-b, chlorophyll-c1, chlorophyll-c2, fucoxanthin, peridinin, phycocyanin, phycoerythrin. Detection can also be done spectroscopically, by the fluorescence emitted from the photo synthetic pigments or using phytoplankton cell count (microscopy, cell sorting), or thermal imaging. Determination and mapping of the infected area can be done using drones or a satellite aerial inspection via multispectral imaging. It can also be done with a probe connected to a boat that crosses the water body to effectively monitor the water surface.

As used herein, the terms “floating composition” and “buoyant composition” may be interchangeably used and refer to compositions formulated for floating on the surface and/or for staying submerged in the water column without sinking to the bottom of the water system. According to some embodiments, the floating/buoyant composition may be essentially disposed on the surface of the water column. In this context, “water column” generally refers to the entire depth of water in a body of water, like an ocean, lake, or stream. It's a vertical section of water extending from the surface down to the bottom.

As used herein, the term “consisting essentially of” with regards to the herein disclosed compositions refers to compositions including less than 2% w/w, less than 1% w/w, less than 0.5% w/w, less than 0.1% w/w, less than 0.05% w/w or less than 0.01% w/w of ingredients other than those disclosed. Each possibility is a separate embodiment.

Reference will now be made in detail to specific aspects of the disclosed materials, compounds, compositions, articles, systems, and methods, examples of which are illustrated in the accompanying examples and figures.

### Compositions

Described herein are aqueous foam precursor compositions. The aqueous foam precursor compositions can comprise an aqueous solution which can form an aqueous-based foam upon combination with an expansion gas. The aqueous foam precursor compositions can comprise a foam-forming agent; an algicide, a flocculant, or a combination thereof; and optionally a solvent such as water.

In some embodiments, the aqueous foam precursor compositions described herein can comprise a foam-forming agent; an algicide; and optionally a solvent such as water. In some embodiments, the aqueous foam precursor compositions can further comprise one or more additional components, including a flocculant, a sorbent, a viscosity-modifying polymer, a foam stabilizer, a pH modifying agent (e.g., an acid, an alkali agent, or a combination thereof), a chelating agent (e.g., EDTA or a salt thereof), a biocide, a colorant, a co-solvent, or any combination thereof.

In other embodiments, the aqueous foam precursor compositions described herein can comprise a foam-forming agent; a flocculant comprising a metal phenolic network (MPN); and optionally a solvent such as water. In some embodiments, the aqueous foam precursor compositions can further comprise one or more additional components, including and algicide, an additional flocculant, a sorbent, a viscosity-modifying polymer, a foam stabilizer, a pH modifying agent (e.g., an acid, an alkali agent, or a combination thereof), a chelating agent (e.g., EDTA or a salt thereof), a biocide, a colorant, a co-solvent, or any combination thereof.

In some embodiments, the aqueous foam precursor composition does not include a solvent. In other embodiments, the aqueous foam precursor composition includes a solvent such as water. In some embodiments, water is present in an amount less than 5% by weight, based on the total weight of the aqueous foam precursor composition. In some embodiments, the water is present in an amount of from 5% by weight to 98% by weight, based on the total weight of the aqueous foam precursor composition. In some embodiments, the aqueous foam precursor composition is a concentrate, and the water is present in an amount of from 5% by weight to 40% by weight, based on the total weight of the aqueous foam precursor composition. In some of these embodiments, the concentrate can be diluted, for example, by mixing with water or a suitable co-solvent, prior to foam formation. In other embodiments, the water can be present in an amount of from 60% by weight to 98% by weight, based on the total weight of the aqueous foam precursor composition. In some embodiments, the aqueous foam precursor composition can be used to form an aqueous-based foam without dilution.

In some embodiments, the aqueous foam precursor compositions described herein can form an aqueous-based foam that exhibits a foam half-life of 5 minutes or more (e.g., 15 minutes or more, 30 minutes or more, 1 hour or more, 2 hours or more, 4 hours or more, 6 hours or more, 8 hours or more, 10 hours or more, 12 hours or more, 14 hours or more, 16 hours or more, 18 hours or more, 20 hours or more, 22 hours or more, or 24 hours or more). In some embodiments, the aqueous foam precursor compositions described herein can form an aqueous-based foam that exhibits a foam half-life of 48 hours or less (e.g., 24 hours or less, 22 hours or less, 20 hours or less, 18 hours or less, 16 hours or less, 14 hours or less, 12 hours or less, 10 hours or less, 8 hours or less, 6 hours or less, 4 hours or less, 2 hours or less, 1 hour or less, 30 minutes or less, or 15 minutes or less).

The aqueous foam precursor compositions described herein can form an aqueous-based foam that exhibits a foam half-life ranging from any of the minimum values described above to any of the maximum values described above. For example, in some embodiments, the aqueous foam precursor compositions described herein can form an aqueous-based foam that exhibits a foam half-life of from 5 minutes to 48 hours (e.g., from 5 minutes to 24 hours, from 5 minutes to 18 hours, from 5 minutes to 12 hours, from 30 minutes to 48 hours, from 30 minutes to 24 hours, from 30 minutes to 18 hours, from 30 minutes to 12 hours, from 1 hour to 24 hours, from 1 hour to 18 hours, from 1 hour to 12 hours, from 2 hours to 24 hours, from 2 hours to 18 hours, from 2 hours to 12 hours).

In some embodiments, the aqueous foam precursor compositions described herein can be packaged as a foamable composition in a container (e.g., a pressurized container, such as a spray can or fire extinguisher) in combination with a liquid or a compressed gas propellant.

### Algicides

The compositions described herein include one or more algicides. Any suitable algicide can be incorporated into the compositions described herein. Non limiting examples of algicides include oxygenic-releasing agents, chlorine releasing agents, bromine-releasing agents, iodine-releasing agents, peroxide-based compounds and peroxide-releasing compounds, copper-releasing agents, manganese-releasing agents, aluminum releasing agents, photosynthesis inhibitors, and combinations thereof. In certain examples, the algicide comprises an oxidant.

Representative examples of algicides include, for example, sodium percarbonate, copper sulfate pentahydrate, calcium hypochlorite, sodium dichloroisocyanurate, alum salts, titanium dioxide, phthalimido-peroxy-hexanoic acid, quaternary ammonium compounds, sodium hypochlorite, chlorine, bronopol, glutaral, alkyl dimethyl benzyl ammonium chloride, alkyl dimethyl benzyl ammonium chloride, 1-(alkylamino)-3-aminopropane monoacetate, trichloro-s-triazinetrione, sodium dichloro-s-triazinetrione, sodium dichloroisocyanurate dehydrate, sodium bromide, poly(oxyethylene (dimethyliminio)ethylene (dimethyliminio)ethylene dichloride), 2-(thiocyanomethylthio) benzothiazole, isopropanol, sodium chlorate, sodium n-bromosulfamate, mixture with sodium n-chlorosulfamate, 1,3-dibromo-5,5-dimethylhydantoin, dodecylguanidine hydrochloride, tetrakis(hydroxymethyl)phosphonium sulphate, 1-bromo-3-chloro-5,5-dimethylhydantoin, sodium chlorite, potassium permanganate, ammonium bromide, copper triethanolamine complex, chlorine dioxide, 2,2-dibromo-3-nitrilopropionamide, 5-chloro-2-methyl-3 (2h)-isothiazolone, sodium dichloroisocyanurate dehydrate, silver, silver sodium hydrogen zirconium phosphate, amino acids (such as but not limited to: arginine, glutamine, L-lysine, methionine), copper ethanolamine complexes, methyldodecylbenzyl trimethyl ammonium chloride and methyldodecylxylylene bis(trimethyl ammonium chloride), lanthanum, aluminum sulfate, 2,4-Dichlorophenoxyacetic acid (2,4-D), 1,1-Ethylene-2,2′-bipyridyldiylium dibromide (Diquat dibromide), 1-methyl-3-phenyl-5-[3-(trifluoromethyl)phenyl]pyridin-4-one (fluridone), N-(phosphonomethyl)glycine (glyphosate), 5-(methoxymethyl)-2-(4-methyl-5-oxo-4-propan-2-yl-1H-imidazol-2-yl)pyridine-3-carboxylic acid (Imazamox), (RS)-2-(4-Methyl-5-oxo-4-propan-2-yl-1H-imidazol-2-yl)pyridine-3-carboxylic acid (Imazapyr), [(3,5,6-Trichloro-2-pyridinyl)oxy]acetic acid (Triclopyr), Endothall (3,6-endoxohexahydrophthalic acid as potassium salt or amine salt), and combinations thereof.

In some examples, the algicide can comprise acetochlor, acifluorfen, aclonifen, acrolein, alachlor, alloxydim, ametryn, amidosulfuron, amitrole, ammonium sulphamate, anilofos, asulam, atrazine, azafenidin, aziptrotryn, azimsulfuron, benazolin, benfluralin, benfuresate, bensulfuron, bensulphide, bentazone, benzofencap, benzthiazuron, bifenox, bispyribac, bispyribac sodium, borax, bromacil, bromobutide, bromofenoxim, bromoxynil, butachlor, butamifos, butralin, butylate, bialaphos, benzoyl-prop, bromobutide, butroxydim, carbetamide, carfentrazone-ethyl, carfenstrol, chlomethoxyfen, chloramben, chlorbromuron, chlorflurenol, chloridazon, chlorimuron, chlornitrofen, chloroacetic acid, chloransulam-methyl, cinidon-ethyl, chlorotoluron, chloroxuron, chlorpropham, chlorsulfuron, chlorthal, chlorthiamide, cinmethylin, cinofulsuron, clefoxydim, clethodim, clomazone, chlomeprop, clopyralid, cyanamide, cyanazine, cycloate, cycloxydim, chloroxynil, clodinafop-propargyl, cumyluron, clometoxyfen, cyhalofop, cyhalofop-butyl, clopyrasuluron, cyclosulphamuron, diclosulam, dichlorprop, dichlorprop-P, diclofop, diethatyl, difenoxuron, difenzoquat, diflufenican, diflufenzopyr, dimefuron, dimepiperate, dimethachlor, dimethipin, dinitramine, dinoseb, dinoseb acetate, dinoterb, diphenamide, dipropetryn, diquat, dithiopyr, diduron, DNOC, DSMA, 2,4-D, daimuron, dalapon, dazomet, 2,4-DB, desmedipham, desmetryn, dicamba, dichlobenil, dimethamid, dithiopyr, dimethametryn, eglinazine, endothal, EPTC, esprocarb, ethalfluralin, ethidimuron, ethofumesate, ethobenzanide, ethoxyfen, ethametsulfuron, ethoxysulfuron, fenoxaprop, fenoxaprop-P, fenuron, flamprop, flamprop-M, flazasulfuron, fluazifop, fluazifop-P, fuenachlor, fluchloralin, flufenacet, flumeturon, fluorocglycofen, fluoronitrofen, flupropanate, flurenol, fluridone, flurochloridone, fluroxypyr, fomesafen, fosamine, fosametine, flamprop-isopropyl, flamprop-isopropyl-L, flufenpyr, flumiclorac-pentyl, flumipropyn, flumioxzim, flurtamon, flumioxzim, flupyrsulfuron-methyl, fluthiacet-methyl, glyphosate, glufosinate-ammonium, haloxyfop, hexazinone, imazamethabenz, isoproturon, isoxaben, isoxapyrifop, imazapyr, imazaquin, imazethapyr, ioxynil, isopropalin, imazosulfuron, imazomox, isoxaflutole, imazapic, ketospiradox, lactofen, lenacil, linuron, MCPA, MCPA-hydrazid, MCPA-thioethyl, MCPB, mecoprop, mecoprop P, mefenacet, mefluidide, mesosulfuron, metam, metamifop, metamitron, metazachlor, methabenzthiazuron, methazole, methoroptryne, methyldymron, methyl isothiocyanate, metobromuron, metoxuron, metribuzin, metsulfuron, molinate, monalide, monolinuron, MSMA, metolachlor, metosulam, metobenzuron, naproanilide, napropamide, naptalam, neburon, nicosulfuron, norflurazon, sodium chlorate, oxadiazon, oxyfluorfen, oxysulfuron, orbencarb, oryzalin, oxadiargyl, propyzamid, prosulfocarb, pyrazolate, pyrazosulfuron, pyrazoxyfen, pyribenzoxim, pyributicarb, pyridate, paraquat, pebulate, pendimethalin, pentachlorophenol, pentoxazone, pentanochlor, petroleum oils, phenmedipham, picloram, piperophos, pretilachlor, primisulfuron, prodiamine, profoxydim, prometryn, propachlor, propanil, propaquizafob, propazine, propham, propisochlor, pyriminobac-methyl, pelargonic acid, pyrithiobac, pyraflufen-ethyl, quinmerac, quinocloamine, quizalofop, quizalofop-P, quinchlorac, rimsulfuron, sethoxydim, sifuron, simazine, simetryn, sulfosulfuron, sulfometuron, sulfentrazone, sulcotrione, sulfosate, tar oils, TCA, TCA sodium, tebutam, tebuthiuron, terbacil, terbumeton, terbutylazine, terbutryn, thiazafluoron, thifensulfuron, thiobencarb, tiocarbazil, tralkoxydim, triallate, triasulfuron, tribenuron, triclopyr, tridiphane, trietazine, trifluralin, tycor, thiadiazimin, thiazopyr, triflusulfuron, vernolate, or a combination thereof.

In some examples, the algicide can comprise a triazine compound, such as, for example, terbutryn, cybutryn, propazine, terbuton, or a combination thereof. In some examples, the algicide can comprise a urea compound, such as, for example, diuron, benzthiazuron, methabenzthiazuron, tebuthiuron isoproturon, or a combination thereof. In some examples, the algicide can comprise a uracil, such as terbacil.

In some embodiments, the algicide can comprise a polyphenol. Examples of polyphenols include stilbenoids (e.g., resveratrol); flavonoids including flavonols, flavones, isoflavones, flavanones, anthocyanidins, flavanols, and flavilliums (e.g., quercetin, luteolin, catechin, epigallocatechin, etc.); tannins, including hydrolysable tannins (e.g., gallic acid, ellagic acid, etc.), condensed tannins (e.g., proanthocyanidols), and phlorotannins (e.g. fucofuroeckol); phenylpropanoids (e.g., curcumin, caffeic acid and derivatives thereof, and in particular esters thereof such as [[(2E)-3-(3,4-dihydroxyphenyl)-1-oxo-2-propenyl]oxy]-3,4-dihydroxybenzenepropanoic acid (rosmarinic acid)); diarylheptanoids: curcuminoids (e.g., tetrahydrocurcumin); aurones (e.g., aureusin); alkylpolyphenols (e.g., cardol); dihydrochalcones; dihydroxycoumarins; polyhydroxyphenylamino acids (e.g., hydroxytyrosine); polyhydroxyphenylamino alcohols (e.g., adrenaline); anthracenone (e.g. aloin); benzenediols and benzenetriols (e.g., pyrogallol); glycosyl polyphenols (e.g., hesperidine, diosmine, etc); and combinations thereof.

In some embodiments, the algicide can comprise a tannin, such as gallic acid, ellagic acid, or a combination thereof.

In some embodiments, the algicide can comprise curcumin.

In some embodiments, the algicide can comprise a hypochlorite salt, hydrogen peroxide, a peroxide-based compounds, a peroxide-releasing compound, or a combination thereof.

In certain embodiments, the algicide can comprise a sodium peroxide, calcium peroxide, potassium peroxide, magnesium peroxide, sodium percarbonate, potassium percarbonate, sodium perborate, potassium perborate, or a combination thereof.

In some embodiments, the algicide can comprise a combination of (1) a polyphenol (e.g., gallic acid, ellagic acid, curcumin, or a combination thereof); and (2) a hypochlorite salt, hydrogen peroxide, a peroxide-based compounds, a peroxide-releasing compound, or a combination thereof (e.g., sodium peroxide, calcium peroxide, potassium peroxide, magnesium peroxide, sodium percarbonate, potassium percarbonate, sodium perborate, potassium perborate, or a combination thereof).

In some embodiments, the algicide can be present in an amount of at least 0.01% by weight, based on the total weight of the aqueous foam precursor composition (e.g., at least 0.05% by weight, at least 0.1% by weight, at least 0.5% by weight, at least 1% by weight, at least 1.5% by weight, at least 2% by weight, at least 2.5% by weight, at least 3% by weight, at least 4% by weight, at least 5% by weight, at least 10% by weight, at least 15% by weight, or at least 20% by weight). In some embodiments, the algicide can be present in an amount of 25% by weight or less, based on the total weight of the aqueous foam precursor composition (e.g., 20% by weight or less, 15% by weight or less, 10% by weight or less, 5% by weight or less, 4% by weight or less, 3% by weight or less, 2.5% by weight or less, 2% by weight or less, 1.5% by weight or less, 1% by weight or less, 0.5% by weight or less, 0.1% by weight or less, or 0.05% by weight or less).

The algicide can be present in an amount ranging from any of the minimum values described above to any of the maximum values described above. For example, in some embodiments, the algicide can be present in an amount of from 0.1% by weight to 25% by weight, based on the total weight of the aqueous foam precursor composition.

### Foam-Forming Agents

The compositions described herein can include one or more foam-forming agents. As used herein, the phrase “foam-forming agent” is meant to include foam producing agents and compounds that are able to generate a foamable composition when admixed with a liquid or gel composition. The foamable composition generates a foam when combined with an expansion gas within a dispensing device or upon dispensing from a dispensing device. Examples of foam-forming agents include surfactants, cholesteryl esters, fatty acid, phospholipids, carbohydrates, proteins, and hydrophobic solvents.

In some examples, the foam-forming agent comprises one or more proteins. The protein may be any kind of protein capable of forming a stable foam.

Proteins are made by chains of amino acids. These chains can either be long chains or branched chains. The larger the number of amino acids present in the protein, the larger the molecular weight of the protein. The amino acids may be either hydrophilic or hydrophobic.

Foam can be defined as a two-phase system comprising air/gas cells separated by a thin continuous liquid layer. Proteins contribute to the uniform distribution of fine air cells in the foam structure. Proteins as foaming agents stabilize foams rapidly and effectively by 1) diffusing the air/water interface and decreasing the surface tension of the air-liquid interface, 2) the proteins unfolding at the interface with orientation of the polar moieties towards the water, 3) polypeptides interacting to form a film around the bubbles with possible partial denaturation. Proteins rapidly adsorb at the interface and form a stabilizing film around bubbles which promote foam formation.

In some examples, the foam-forming agent comprises one or more proteins, such as whey protein, ovalbumin, conalbumin, globulins, ovomucin, or a combination thereof.

In some examples, the foam-forming agent comprises one or more surfactants. Suitable surfactants can include natural and synthetic ionic or non-ionic surfactants. In some embodiments, the foam-forming agent can comprise an anionic surfactant, a non-ionic surfactant, or any combination thereof. Suitable surfactants (and combinations of surfactants) are known in the art as discussed in more detail below.

In some examples, suitable anionic surfactants include a hydrophobic tail that comprises from 6 to 60 carbon atoms. In some embodiments, the anionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the anionic surfactant can include a hydrophobic tail that comprises 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The anionic surfactant can include a hydrophobic tail that comprises a number of carbon atoms ranging from any of the minimum values described above to any of the maximum values described above. For example, in some embodiments, the anionic surfactant can comprise a hydrophobic tail comprising from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. The hydrophobic (lipophilic) carbon tail may be a straight chain, branched chain, and/or may comprise cyclic structures. The hydrophobic carbon tail may comprise single bonds, double bonds, triple bonds, or any combination thereof. In some embodiments, the anionic surfactant can include a branched hydrophobic tail derived from Guerbet alcohols. The hydrophilic portion of the anionic surfactant can comprise, for example, one or more sulfate moieties (e.g., one, two, or three sulfate moieties), one or more sulfonate moieties (e.g., one, two, or three sulfonate moieties), one or more sulfosuccinate moieties (e.g., one, two, or three sulfosuccinate moieties), one or more carboxylate moieties (e.g., one, two, or three carboxylate moieties), or any combination thereof.

In some embodiments, the anionic surfactant can comprise, for example a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof. In some examples, the anionic surfactant can comprise an internal olefin sulfonate (IOS), an isomerized olefin sulfonate, an alfa olefin sulfonate (AOS), an alkyl aryl sulfonate (AAS), a xylene sulfonate, an alkane sulfonate, a petroleum sulfonate, an alkyl diphenyl oxide (di) sulfonate, an alcohol sulfate, an alkoxy sulfate, an alkoxy sulfonate, an alkoxy carboxylate, an alcohol phosphate, or an alkoxy phosphate. In some embodiments, the anionic surfactant can comprise an alkoxy carboxylate surfactant, an alkoxy sulfate surfactant, an alkoxy sulfonate surfactant, an alkyl sulfonate surfactant, an aryl sulfonate surfactant, or an olefin sulfonate surfactant. In some embodiments, the anionic surfactant can comprise an olefin sulfonate surfactant. In some embodiments, the anionic surfactant can comprise a C14-C16 olefin sulfonate surfactant. In some embodiments, the anionic surfactant can comprise an isomerized C14-C16 olefin sulfonate surfactant.

An “alkoxy carboxylate surfactant” or “alkoxy carboxylate” refers to a compound having an alkyl or aryl attached to one or more alkoxylene groups (typically —CH₂—CH(ethyl)-O—, —CH₂—CH(methyl)-O—, or —CH₂—CH₂—O—) which, in turn is attached to —COO⁻ or acid or salt thereof including metal cations such as sodium. In embodiments, the alkoxy carboxylate surfactant can be defined by the formulae below:

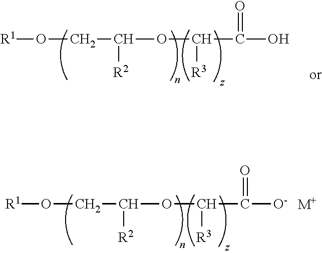

wherein R¹ is substituted or unsubstituted C6-C36 alkyl or substituted or unsubstituted aryl; R² is, independently for each occurrence within the compound, hydrogen or unsubstituted C₁-C₆ alkyl; R³ is independently hydrogen or unsubstituted C₁-C₆ alkyl, n is an integer from 0 to 175, z is an integer from 1 to 6 and M is a monovalent, divalent or trivalent cation. In some of these embodiments, R¹ can be an unsubstituted linear or branched C6-C36 alkyl.

In certain embodiments, the alkoxy carboxylate can be a C6-C32:PO(0-65):EO(0-100)-carboxylate (i.e., a C6-C32 hydrophobic tail, such as a branched or unbranched C6-C32 alkyl group, attached to from 0 to 65 propyleneoxy groups (—CH₂—CH(methyl)-O-linkers), attached in turn to from 0 to 100 ethyleneoxy groups (—CH₂—CH₂—O-linkers), attached in turn to —COO⁻ or an acid or salt thereof including metal cations such as sodium). In certain embodiments, the alkoxy carboxylate can be a branched or unbranched C6-C30:PO(30-40):EO(25-35)-carboxylate.

In certain embodiments, the alkoxy carboxylate can be a branched or unbranched C6-C12:PO(30-40):EO(25-35)-carboxylate. In certain embodiments, the alkoxy carboxylate can be a branched or unbranched C6-C30:EO(8-30)-carboxylate.

An “alkoxy sulfate surfactant” or “alkoxy sulfate” refers to a surfactant having an alkyl or aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In some embodiment, the alkoxy sulfate surfactant has the formula R—(BO)ₑ—(PO)_{f}-(EO)_{g}—SO₃; or acid or salt (including metal cations such as sodium) thereof, wherein R is C6-C32 alkyl, BO is —CH₂—CH(ethyl)-O—, PO is —CH₂—CH(methyl)-O—, and EO is —CH₂—CH₂—O—. The symbols e, f and g are integers from 0 to 50 wherein at least one is not zero.

In embodiments, the alkoxy sulfate surfactant can be an aryl alkoxy sulfate surfactant. The aryl alkoxy surfactant can be an alkoxy surfactant having an aryl attached to one or more alkoxylene groups (typically —CH₂—CH(ethyl)-O—, —CH₂—CH(methyl)-O—, or —CH₂—CH₂—O—) which, in turn is attached to —SO₃; or acid or salt thereof including metal cations such as sodium.

An “alkyl sulfonate surfactant” or “alkyl sulfonate” refers to a compound that includes an alkyl group (e.g., a branched or unbranched C6-C32 alkyl group) attached to —SO₃⁻ or acid or salt thereof including metal cations such as sodium.

An “aryl sulfate surfactant” or “aryl sulfate” refers to a compound having an aryl group attached to —O—SO₃; or acid or salt thereof including metal cations such as sodium. An “aryl sulfonate surfactant” or “aryl sulfonate” refers to a compound having an aryl group attached to —SO₃⁻ or acid or salt thereof including metal cations such as sodium. In some cases, the aryl group can be substituted, for example, with an alkyl group (an alkyl aryl sulfonate).

An “internal olefin sulfonate,” “isomerized olefin sulfonate,” or “IOS” refers to an unsaturated hydrocarbon compound comprising at least one carbon-carbon double bond and at least one SO₃ group, or a salt thereof. As used herein, a “C20-C28 internal olefin sulfonate,” “a C20-C28 isomerized olefin sulfonate,” or “C20-C28 IOS” refers to an IOS, or a mixture of IOSs with an average carbon number of 20 to 28, or of 23 to 25. The C20-C28 IOS may comprise at least 80% of IOS with carbon numbers of 20 to 28, at least 90% of IOS with carbon numbers of 20 to 28, or at least 99% of IOS with carbon numbers of 20 to 28. As used herein, a “C15-C18 internal olefin sulfonate,” “C15-C18 isomerized olefin sulfonate,” or “C15-C18 IOS” refers to an IOS or a mixture of IOSs with an average carbon number of 15 to 18, or of 16 to 17. The C15-C18 IOS may comprise at least 80% of IOS with carbon numbers of 15 to 18, at least 90% of IOS with carbon numbers of 15 to 18, or at least 99% of IOS with carbon numbers of 15 to 18. The internal olefin sulfonates or isomerized olefin sulfonates may be alpha olefin sulfonates, such as an isomerized alpha olefin sulfonate. The internal olefin sulfonates or isomerized olefin sulfonates may also comprise branching. In certain embodiments, C15-18 IOS may be added to the single-phase liquid surfactant package when the LPS injection fluid is intended for use in high temperature unconventional subterranean formations, such as formations above 130° F. (approximately 55° C.). The IOS may be at least 20% branching, 30% branching, 40% branching, 50% branching, 60% branching, or 65% branching. In some embodiments, the branching is between 20-98%, 30-90%, 40-80%, or around 65%. Examples of internal olefin sulfonates and the methods to make them are found in U.S. Pat. No. 5,488,148, U.S. Patent Application Publication 2009/0112014, and SPE 129766, all incorporated herein by reference.

In embodiments, the anionic surfactant can be a disulfonate, alkyldiphenyloxide disulfonate, mono alkyldiphenyloxide disulfonate, di alkyldiphenyloxide disulfonate, or a di alkyldiphenyloxide monosulfonate, where the alkyl group can be a C6-C36 linear or branched alkyl group. In embodiments, the anionic surfactant can be an alkylbenzene sulfonate or a dibenzene disufonate. In embodiments, the anionic surfactant can be benzenesulfonic acid, decyl(sulfophenoxy)-disodium salt; linear or branched C6-C36 alkyl:PO(0-65):EO(0-100) sulfate; or linear or branched C6-C36 alkyl:PO(0-65):EO(0-100) carboxylate. In embodiments, the anionic surfactant is an isomerized olefin sulfonate (C6-C30), internal olefin sulfonate (C6-C30) or internal olefin disulfonate (C6-C30). In some embodiments, the anionic surfactant is a Guerbet-PO(0-65)-EO (0-100) sulfate (Guerbet portion can be C6-C36). In some embodiments, the anionic surfactant is a Guerbet-PO(0-65)-EO (0-100) carboxylate (Guerbet portion can be C6-C36). In some embodiments, the anionic surfactant is alkyl PO(0-65) and EO (0-100) sulfonate, where the alkyl group is linear or branched C6-C36. In some embodiments, the anionic surfactant is a sulfosuccinate, such as a dialkylsulfosuccinate. In some embodiments, the anionic surfactant is an alkyl aryl sulfonate (AAS) (e.g. an alkyl benzene sulfonate (ABS)), a C10-C30 internal olefin sulfate (IOS), a petroleum sulfonate, or an alkyl diphenyl oxide (di) sulfonate.

In some examples, the anionic surfactant can comprise a surfactant defined by the formula below:

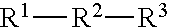

wherein R¹ comprises a branched or unbranched, saturated or unsaturated, cyclic or non-cyclic, hydrophobic carbon chain having 6-32 carbon atoms and an oxygen atom linking R¹ and R²; R² comprises an alkoxylated chain comprising at least one oxide group selected from the group consisting of ethylene oxide, propylene oxide, butylene oxide, and combinations thereof; and R³ comprises a branched or unbranched hydrocarbon chain comprising 2-12 carbon atoms and from 2 to 5 carboxylate groups.

In some examples, the anionic surfactant can comprise a surfactant defined by the formula below:

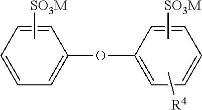

wherein R⁴ is a branched or unbranched, saturated or unsaturated, cyclic or non-cyclic, hydrophobic carbon chain having 6-32 carbon atoms; and M represents a counterion (e.g., Na⁺, K⁺). In some embodiments, R⁴ is a branched or unbranched, saturated or unsaturated, cyclic or non-cyclic, hydrophobic carbon chain having 6-16 carbon atoms.

Suitable non-ionic surfactants include compounds that can be added to increase wettability. In embodiments, the hydrophilic-lipophilic balance (HLB) of the non-ionic surfactant is greater than 10 (e.g., greater than 9, greater than 8, or greater than 7). In some embodiments, the HLB of the non-ionic surfactant is from 7 to 10.

The non-ionic surfactant can comprise a hydrophobic tail comprising from 6 to 60 carbon atoms. In some embodiments, the non-ionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the non-ionic surfactant can include a hydrophobic tail that comprises 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The non-ionic surfactant can include a hydrophobic tail that comprises a number of carbon atoms ranging from any of the minimum values described above to any of the maximum values described above. For example, in some embodiments, the non-ionic surfactant can comprise a hydrophobic tail comprising from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. In some cases, the hydrophobic tail may be a straight chain, branched chain, and/or may comprise cyclic structures. The hydrophobic carbon tail may comprise single bonds, double bonds, triple bonds, or any combination thereof. In some cases, the hydrophobic tail can comprise an alkyl group, with or without an aromatic ring (e.g., a phenyl ring) attached to it. In some embodiments, the hydrophobic tail can comprise a branched hydrophobic tail derived from Guerbet alcohols.

Example non-ionic surfactants include alkyl aryl alkoxy alcohols, alkyl alkoxy alcohols, or any combination thereof. In embodiments, the non-ionic surfactant may be a mix of surfactants with different length lipophilic tail chain lengths. For example, the non-ionic surfactant may be C9-C11:9EO, which indicates a mixture of non-ionic surfactants that have a lipophilic tail length of 9 carbon to 11 carbon, which is followed by a chain of 9 EOs. The hydrophilic moiety is an alkyleneoxy chain (e.g., an ethoxy (EO), butoxy (BO) and/or propoxy (PO) chain with two or more repeating units of EO, BO, and/or PO). In some embodiments, 1-100 repeating units of EO are present. In some embodiments, 0-65 repeating units of PO are present. In some embodiments, 0-25 repeating units of BO are present. For example, the non-ionic surfactant could comprise 10EO: 5PO or 5EO. In embodiments, the non-ionic surfactant may be a mix of surfactants with different length lipophilic tail chain lengths. For example, the non-ionic surfactant may be C9-C11:PO9:EO2, which indicates a mixture of non-ionic surfactants that have a lipophilic tail length of 9 carbon to 11 carbon, which is followed by a chain of 9 POs and 2 EOs. In specific embodiments, the non-ionic surfactant is linear C9-C11:9EO. In some embodiments, the non-ionic surfactant is a Guerbet PO(0-65) and EO (0-100) (Guerbet can be C6-C36); or alkyl PO(0-65) and EO (0-100): where the alkyl group is linear or branched C1-C36. In some examples, the non-ionic surfactant can comprise a branched or unbranched C6-C32:PO(0-65):EO(0-100) (e.g., a branched or unbranched C6-C30:PO(30-40):EO(25-35), a branched or unbranched C6-C12:PO(30-40):EO(25-35), a branched or unbranched C6-30:EO(8-30), or any combination thereof). In some embodiments, the non-ionic surfactant is one or more alkyl polyglucosides.

Examples of suitable primary foaming surfactants are disclosed, for example, in U.S. Pat. Nos. 3,811,504, 3,811,505, 3,811,507, 3,890,239, 4,463,806, 6,022,843, 6,225,267, 7,629,299, 7,770,641, 9,976,072, 8,211, 837, 9,422,469, 9,605,198, and 9,617,464; WIPO Patent Application Nos. WO/2008/079855, WO/2012/027757 and WO/2011/094442; as well as U.S. Patent Application Nos. 2005/0199395, 2006/0185845, 2006/0189486, 2009/0270281, 2011/0046024, 2011/0100402, 2011/0190175, 2007/0191633, 2010/004843. 2011/0201531, 2011/0190174, 2011/0071057, 2011/0059873, 2011/0059872, 2011/0048721, 2010/0319920, 2010/0292110, and 2017/0198202, each of which is hereby incorporated by reference herein in its entirety for its description of example surfactants.

Suitable surfactants can also comprise one or more cationic surfactants. Example cationic surfactants include surfactant analogous to those described above, except bearing primary, secondary, or tertiary amines, or quaternary ammonium cations, as a hydrophilic head group. Suitable surfactants can also comprise one or more zwitterionic surfactants. “Zwitterionic” or “zwitterion” as used herein refers to a neutral molecule with a positive (or cationic) and a negative (or anionic) electrical charge at different locations within the same molecule. Example zwitterionic surfactants include betains and sultains

In some examples, the one or more surfactants can comprise sodium lauryl sulfate (SLS). SLS is commonly used in industrial cleaning products and detergents. SLS is known for its strong foaming properties.

In some examples, the one or more surfactants can comprise cocamidopropyl betaine. This surfactant is often used in cleaning formulations and can enhance foam stability while being milder on surfaces.

In some examples, the one or more surfactants can comprise an Alkyl Polyglucoside (APG). Derived from renewable resources, these non-ionic surfactants are effective in various cleaning applications, including household and industrial cleaners, and provide good foaming.

In some examples, the one or more surfactants can comprise a Quillaja Saponaria extract. Known for its natural foaming properties, this extract is used in firefighting foams and as a foaming agent in various industrial applications.

In some examples, the one or more surfactants can comprise sodium cocoyl isethionate (SCI). While often found in personal care products, SCI is also effective in industrial cleaning formulations due to its excellent foaming and mildness.

In some examples, the one or more surfactants can comprise potassium lauryl sulfate. Similar to SLS, this surfactant is used in various cleaning products and is known for its ability to produce stable foam.

In some embodiments, the one or more surfactants can comprise a non-ionic surfactant.

In some examples, the one or more surfactants can comprise a polysorbate-type nonionic surfactant formed by the ethoxylation of sorbitan monolaurate. Examples of polysorbates include polysorbate 20 (polyoxyethylene (20) sorbitan monolaurate), polysorbate 40 (polyoxyethylene (20) sorbitan monopalmitate), polysorbate 60 (polyoxyethylene (20) sorbitan monostearate), polysorbate 80 (polyoxyethylene (20) sorbitan monooleate), or a combination thereof.

In some embodiments, the one or more surfactants can comprise an alkyl polyglycoside.

In some embodiments, the one or more surfactants can comprise one or more anionic surfactants.

In some embodiments, the one or more surfactants can comprise a sulfate surfactant, a sulfonate surfactant, a carboxylate surfactant, or a combination thereof.

In some embodiments, the one or more surfactants can comprise sodium lauryl sulfate (SLS), sodium cocoyl isethionate (SCI), potassium lauryl sulfate, or a combination thereof.

In some embodiments, the one or more surfactants can comprise a glycoside saponin, such as a glycoside saponin extracted from Quillaja saponaria, a glycoside saponin extracted from soapwort (Saponaria officinalis), a glycoside saponin extracted from senega root (Polygala senega), a glycoside saponin extracted from sarsaparilla (Smilax ornata).

In some embodiments, the one or more surfactants can comprise one or more zwitterionic surfactants, such as cocamidopropyl betaine.

In some examples, the foam-forming agent comprises a hydrophobic solvent, petrolatum, paraffin wax, a fatty alcohol, a fatty acid, a wax, shea butter, or a combination thereof.

In some embodiments, the foam-forming agent(s) can be present in an amount of at least 0.01% by weight, based on the total weight of the aqueous foam precursor composition (e.g., at least 0.05% by weight, at least 0.1% by weight, at least 0.5% by weight, at least 1% by weight, at least 1.5% by weight, at least 2% by weight, at least 2.5% by weight, at least 3% by weight, at least 4% by weight, at least 5% by weight, at least 10% by weight, at least 15% by weight, or at least 20% by weight). In some embodiments, the foam-forming agent(s) can be present in an amount of 25% by weight or less, based on the total weight of the aqueous foam precursor composition (e.g., 20% by weight or less, 15% by weight or less, 10% by weight or less, 5% by weight or less, 4% by weight or less, 3% by weight or less, 2.5% by weight or less, 2% by weight or less, 1.5% by weight or less, 1% by weight or less, 0.5% by weight or less, 0.1% by weight or less, or 0.05% by weight or less).

The foam-forming agent(s) can be present in an amount ranging from any of the minimum values described above to any of the maximum values described above. For example, in some embodiments, the foam-forming agent(s) can be present in an amount of from 0.1% by weight to 25% by weight, based on the total weight of the aqueous foam precursor composition.

### Flocculants

In some embodiments, the aqueous foam precursor composition further comprises a flocculant.

Examples of suitable flocculants include metal phenolic networks (MPN), polymeric flocculants (e.g., polyelectrolytes), metal salts (e.g., aluminum sulfate, ferric sulfate, and ferric chloride), clays, and combinations thereof.

In some embodiments, the flocculant can comprise an MPN. The MPN can comprise, for example a polyphenol, a polysaccharide, and a metal cation. In some embodiments, the polyphenol comprises a plurality of catechol moieties. In certain embodiments, the polyphenol comprises tannic acid. In some embodiments, the polysaccharide comprises chitosan. In some embodiments, the metal cation comprises Fe³⁺, Mg²⁺, or a combination thereof. Examples of MPNs are further described in U.S. Pat. No. 11,439,150, which is incorporated herein by reference in its entirety.

In some embodiments, the flocculant comprises a polymer flocculant. Examples of polymeric flocculants include synthetic polymers, natural biopolymers (e.g., polysaccharides), derivatized natural biopolymers, or any combination thereof.

Examples of polymeric flocculants include poly oxyethylene, polyvinyl alcohol, polyvinyl pyrrolidone, a polyacrylic acid, a polyphosphoric acid, a polystyrene sulfonic acid, chitosan acetate, chitosan lactate, chitosan adipate, chitosan glutamate, chitosan succinate, chitosan malate, chitosan citrate, chitosan fumarate, chitosan hydrochloride, guar, cationic guar, anionic guar, starch, cationic starch, anionic starch, carrageenan, methylcellulose, hydroxypropylcellulose, sodium carboxymethylcellulose, hydroxymethylcellulose, hydroxypropylmethylcellulose, hydroxyethylcellulose, xanthan, alginates, pectins, glucomannans, galactomannans, copolymers thereof, and blends thereof.

In some embodiments, the flocculant can comprise an aluminum salt, which may be monomeric or polymeric, and a polybasic organic carboxylic acid. These can be present in molar ratios (Al:carboxylic acid) of 0.5:1 to 50:1, such as 2:1 to 10:1.

A monomeric or polymeric aluminum salt includes a trivalent aluminum salt in monomeric or polymer form. An example salt is aluminum hydroxy-chloride in both monomeric and polymeric form. Also of value are, for example, non-polymeric aluminum salts such as aluminum chloride or aluminum sulfate. These salts are all commercially available.

A polybasic carboxylic acid is an organic carboxylic acid having at least two active protons. Included among polybasic organic carboxylic acids, are those commercially available and, as examples which have proved suitable as flocculating agents with aluminum salts are: citric acid; glycolic acid; tartaric acid; maleic acid; hydroxymaleic acids; hydroxytartaric acids; malonic acid; malic acid; lactic acid (α-hydroxypropionic acid); tartronic acid; sugar acids, such as gluconic acid; saccharic acid; glucuronic acid; mucic acid; and mannosaccharic acid.

Citric acid and, especially, tartaric acid bring about a very pronounced lowering of the toxicity limit that is associated with the carbonate hardness or alkalinity.

In one example, the flocculant can comprise polymeric aluminum hydroxy-chloride and tartaric acid.

In some embodiments, the flocculant comprises poly-aluminum chloride (PAC).

In some embodiments, the flocculant comprises a clay, such as kaolinite, montmorillonite-smectite, illite, chlorite, vermiculite, talc, pyrophyllite, and combinations thereof.

In some embodiments, the flocculant comprises a combination of poly-aluminum chloride (PAC) and kaolinite.

In some embodiments, the flocculant can be present in an amount of at least 0.01% by weight, based on the total weight of the aqueous foam precursor composition (e.g., at least 0.05% by weight, at least 0.1% by weight, at least 0.5% by weight, at least 1% by weight, at least 1.5% by weight, at least 2% by weight, at least 2.5% by weight, at least 3% by weight, at least 4% by weight, at least 5% by weight, at least 10% by weight, at least 15% by weight, or at least 20% by weight). In some embodiments, the flocculant can be present in an amount of 25% by weight or less, based on the total weight of the aqueous foam precursor composition (e.g., 20% by weight or less, 15% by weight or less, 10% by weight or less, 5% by weight or less, 4% by weight or less, 3% by weight or less, 2.5% by weight or less, 2% by weight or less, 1.5% by weight or less, 1% by weight or less, 0.5% by weight or less, 0.1% by weight or less, or 0.05% by weight or less).

The flocculant can be present in an amount ranging from any of the minimum values described above to any of the maximum values described above. For example, in some embodiments, the flocculant can be present in an amount of from 0.1% by weight to 25% by weight, based on the total weight of the aqueous foam precursor composition

### Additional Components

In some embodiments, the aqueous foam precursor compositions can further comprise one or more additional components, including a flocculant, a sorbent, a viscosity-modifying polymer, a foam stabilizer, a pH modifying agent (e.g., an acid, an alkali agent, or a combination thereof), a chelating agent (e.g., EDTA or a salt thereof), a biocide, a colorant, a co-solvent, or any combination thereof.

### Viscosity-Modifying Polymers

The aqueous foam precursor compositions can comprise any suitable viscosity-modifying polymer. The viscosity-modifying polymer can comprise a synthetic polymer, a naturally occurring polymer (a biopolymer), or any combination thereof.

In some examples, the viscosity-modifying polymer can comprise a synthetic polymer. Examples of suitable synthetic polymers include polyacrylamides, such as partially hydrolyzed polyacrylamides (HPAMs or PHPAs), and hydrophobically-modified associative polymers (APs). Other examples include co-polymers of polyacrylamide (PAM) and one or both of 2-acrylamido 2-methylpropane sulfonic acid (and/or sodium salt) commonly referred to as AMPS (also more generally known as acrylamido tertiobutyl sulfonic acid or ATBS), N-vinyl pyrrolidone (NVP), and the NVP-based synthetic may be single-, co-, or ter-polymers. In one embodiment, the synthetic polymer is polyacrylic acid (PAA). In one embodiment, the synthetic polymer is polyvinyl alcohol (PVA). Copolymers may be made of any combination or mixture above, for example, a combination of NVP and ATBS.

In some examples, the viscosity-modifying polymer can comprise a synthetic polymer, such as hydrolyzed polyacrylamide (HPAM), N-vinylpyrrolidone (NVP), acrylamide tertiary butyl sulfonic acid (ATBS), 2-acrylamido-2-methylpropane sulfonic acid (AMPS), or any combination thereof. In some examples, the viscosity-modifying polymer can comprise a blend of a biopolymer and a synthetic polymer.

In some examples, the viscosity-modifying polymer can comprise a biopolymer, such as a triple-helix forming biopolymer. In some examples, the viscosity-modifying polymer comprises a polysaccharide. In some examples, the viscosity-modifying polymer can be selected from the group consisting of xanthan, guar, a scleroglucan, a schizophyllan, hydroxyethyl cellulose (HEC), or any combination thereof.

The viscosity-modifying polymer can, for example, be present in an amount of 0.01% or more by weight, based on the total weight of the aqueous foam precursor composition (e.g., 0.05% or more, 0.1% or more, 0.15% or more, 0.2% or more, 0.25% or more, 0.3% or more, 0.35% or more, 0.4% or more, 0.45% or more, 0.5% or more, 0.55% or more, 0.6% or more, 0.65% or more, 0.7% or more, 0.75% or more, 0.8% or more, 0.85% or more, or 0.9% or more). In some examples, the viscosity-modifying polymer can be present in an amount of 1% or less by weight, based on the total weight of the aqueous foam precursor composition (e.g., 0.95% or less, 0.9% or less, 0.85% or less, 0.8% or less, 0.75% or less, 0.7% or less, 0.65% or less, 0.6% or less, 0.55% or less, 0.5% or less, 0.45% or less, 0.4% or less, 0.35% or less, 0.3% or less, 0.25% or less, 0.2% or less, 0.15% or less, or 0.1% or less).

The amount of the viscosity-modifying polymer present can range from any of the minimum values described above to any of the maximum values described above. For example, the viscosity-modifying polymer can be present in an amount of from 0.01% to 1% by weight, based on the total weight of the aqueous foam precursor composition (e.g., from 0.01% to 0.5%, from 0.5% to 1%, from 0.01% to 0.2%, from 0.2% to 0.4%, from 0.4% to 0.6%, from 0.6% to 0.8%, from 0.8% to 1%, from 0.01% to 0.9%, from 0.1% to 1%, from 0.1% to 0.9%, or from 0.01% to 0.75%).

### Foam Stabilizers

The aqueous foam precursor compositions can comprise any suitable foam stabilizer. Examples of suitable foam stabilizers can include, for example, fluorosurfactants, crosslinkers, particulate stabilizers, or any combination thereof.

In some embodiments, the aqueous foam precursor compositions can comprise a fluorosurfactant. Fluorosurfactants are surfactants that include at least one fluorine atom. Examples of fluorosurfactants include perfluoroalkylethyl phosphates, perfluoroalkylethyl betaines, fluoroaliphatic amine oxides, fluoroaliphatic sodium sulfosuccinates, fluoroaliphatic stearate esters, fluoroaliphatic phosphate esters, fluoroaliphatic quaternaries, fluoroaliphatic polyoxyethylenes, and the like, and mixtures thereof.

In some examples, the fluorosurfactant can comprise a charged species, i.e. the fluorosurfactant can be an anionic, cationic, or zwitterionic fluorosurfactant. Examples of fluorosurfactants containing a charged species include perfluoroalkylethyl phosphates, perfluoroalkylethyl betaines, fluoroaliphatic amine oxides, fluoroaliphatic sodium sulfosuccinates, fluoroaliphatic phosphate esters, and fluoroaliphatic quaternaries. Specific examples of fluorosurfactants include DEA-C8-18 perfluoroalkylethyl phosphate, TEA-C8-18 perfluoroalkylethyl phosphate, NH₄—C8-18 perfluoroalkylethyl phosphate, and C8-18 perfluoroalkylethyl betaine.

In some embodiments, the fluorosurfactant can be a compound the formula [F₃CF₂C—(CF₂CF₂)ₓ—CH₂CH₂—O—P₂O₃]⁻[R¹]⁺ where [R¹]⁺ includes DEA, TEA, NH₄, or betaine, and where x is an integer from about 4 to about 18.

In some embodiments, the fluorosurfactant can comprise a fluoroaliphatic sulfosuccinate, a fluoroaliphatic sulfonate, an ethoxylated fluorinated alcohol, or any combination thereof.

In some embodiments, the aqueous foam precursor compositions can comprise a crosslinker. Suitable crosslinkers are known in the art and can be selected based on a number of factors including the identity of the viscosity-modifying polymer. Examples of suitable crosslinking agents include borate crosslinking agents, Zr crosslinking agents, Ti crosslinking agents, Al crosslinking agents, organic crosslinkers (e.g., malonate, polyethyleneimine), and combinations thereof.

In some embodiments, the aqueous foam precursor compositions can comprise a particulate stabilizer (e.g., nanoparticles or microparticles). Examples of suitable nanoparticles and microparticles are known in the art, and include, for example, nickel oxide, alumina, silica (surface-modified), a silicate, iron oxide (Fe₃O₄), titanium oxide, impregnated nickel on alumina, synthetic clay, natural clay, iron zinc sulfide, magnetite, iron octanoate, or any combination thereof. In some examples, the foamed composition can further include a particulate stabilizer comprising a synthetic clay, a natural clay, or any combination thereof, such as attapulgite, bentonite, or any combination thereof. Other examples of suitable nanoparticles are described, for example, in U.S. Pat. No. 10,266,750, which is hereby incorporated by reference in its entirety.

In some examples, the foamed composition can include a particulate stabilizer having an average particle size of 100 nanometers (nm) or more (e.g., 200 nm or more, 300 nm or more, 400 nm or more, 500 nm or more, 750 nm or more, 1 micrometer (micron, μm) or more, 2 μm or more, 3 μm or more, 4 μm or more, 5 μm or more, 10 μm or more, 15 μm or more, or 20 μm or more). In some examples, the particulate stabilizer can have an average particle size of 25 μm or less (e.g., 20 μm or less, 15 μm or less, 10 μm or less, 5 μm or less, 4 μm or less, 3 μm or less, 2 μm or less, 1 μm or less, 750 nm or less, 500 nm or less, 400 nm or less, or 300 nm or less). The average particle size of the particulate stabilizer can range from any of the minimum values described above to any of the maximum values described above. For example, the particulate stabilizer can have an average particle size of from 100 nm to 25 μm (e.g., from 100 nm to 10 μm, from 100 nm to 5 μm, from 100 nm to 100 μm, from 100 μm to 500 μm, from 100 nm to 200 μm, from 100 nm to 150 μm, from 100 nm to 100 μm, from 100 nm to 50 μm, or from 100 nm to 10 μm).

The foam stabilizer can, for example, be present in an amount of 0.01% or more by weight, based on the total weight of the aqueous foam precursor composition (e.g., 0.05% or more, 0.1% or more, 0.15% or more, 0.2% or more, 0.25% or more, 0.3% or more, 0.35% or more, 0.4% or more, 0.45% or more, 0.5% or more, 0.6% or more, 0.7% or more, 0.8% or more, 0.9% or more, 1% or more, 1.25% or more, 1.5% or more, 1.75% or more, 2% or more, 2.5% or more, 3% or more, 3.5% or more, 4% or more, 4.5% or more, 5% or more, 5.5% or more, 6% or more, 6.5% or more, 7% or more, 7.5% or more, 8% or more, 8.5% or more, or 9% or more). In some examples, the foam stabilizer can be present in an amount of 10% or less by weight, based on the total weight of the aqueous foam precursor composition (e.g., 9.5% or less, 9% or less, 8.5% or less, 8% or less, 7.5% or less, 7% or less, 6.5% or less, 6% or less, 5.5% or less, 5% or less, 4.5% or less, 4% or less, 3.5% or less, 3% or less, 2.5% or less, 2% or less, 1.75% or less, 1.5% or less, 1.25% or less, 1% or less, 0.9% or less, 0.8% or less, 0.7% or less, 0.6% or less, 0.5% or less, 0.45% or less, 0.4% or less, 0.35% or less, 0.3% or less, 0.25% or less, 0.2% or less, 0.15% or less, or 0.1% or less). The amount of foam stabilizer present can range from any of the minimum values described above to any of the maximum values described above. For example, the foam stabilizer can be present in an amount of from 0.01% to 10% by weight, based on the total weight of the aqueous foam precursor composition (e.g., from 0.01% to 5%, from 5% to 10%, from 0.01% to 2%, from 2% to 4%, from 4% to 6%, from 6% to 8%, from 8% to 10%, from 0.01% to 8%, from 0.01% to 6%, from 0.01% to 4%, from 0.01% to 1%, from 0.01% to 0.5%, or from 0.01% to 0.2%).

### Sorbents

In some embodiments, the aqueous foam precursor compositions can comprise a sorbent.

The sorbent can comprise a particulate sorbent that can absorb a toxin produced by phytoplankton, such as microcystins, nodularins, anatoxin, cylindrospermopsins, lyngbyatoxin, saxitoxin, lipopolysaccharides, paralytic shellfish toxin (PST), aplysiatoxins, β-Methylamino-L-alanine (BMAA), brevetoxins, ptychodiscus, or a combination thereof.

In some examples, the sorbent comprises carbon black, activated carbon, a molecular sieve, diatomaceous earth, graphite, charcoal, a porous polymer, or an AmiSorb particle.

In some embodiments, the sorbent can be present in an amount of at least 0.1% by weight, based on the total weight of the aqueous foam precursor composition (e.g., at least 0.5% by weight, at least 1% by weight, at least 1.5% by weight, at least 2% by weight, at least 2.5% by weight, at least 3% by weight, at least 4% by weight, at least 5% by weight, at least 10% by weight, at least 15% by weight, or at least 20% by weight). In some embodiments, the sorbent can be present in an amount of 25% by weight or less, based on the total weight of the aqueous foam precursor composition (e.g., 20% by weight or less, 15% by weight or less, 10% by weight or less, 5% by weight or less, 4% by weight or less, 3% by weight or less, 2.5% by weight or less, 2% by weight or less, 1.5% by weight or less, 1% by weight or less, or 0.5% by weight or less).

The sorbent can be present in an amount ranging from any of the minimum values described above to any of the maximum values described above. For example, in some embodiments, the sorbent can be present in an amount of from 0.1% by weight to 25% by weight, based on the total weight of the aqueous foam precursor composition

### Co-Solvents

In some examples, the aqueous foam precursor compositions can further comprise a co-solvent. Examples of co-solvents include, but are not limited to alcohols, such as lower carbon chain alcohols such as isopropyl alcohol, ethanol, n-propyl alcohol, n-butyl alcohol, sec-butyl alcohol, n-amyl alcohol, sec-amyl alcohol, n-hexyl alcohol, sec-hexyl alcohol and the like; alcohol ethers, polyalkylene alcohol ethers, polyalkylene glycols, poly(oxyalkylene)glycols, poly(oxyalkylene)glycol ethers, ethoxylated phenol, or any other common organic co-solvent or combinations of any two or more co-solvents. In one embodiment, the co-solvent can comprise alkyl ethoxylate (C1-C6)-XEO X=1-30-linear or branched. In some embodiments, the co-solvent can comprise ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), diethylene glycol, polyethylene glycol (PEG), or any combination thereof. In some embodiments, the co-solvent can comprise ethylene glycol butyl ether (EGBE) and diethylene glycol.

### Foams

Also described herein are aqueous-based foams comprising an aqueous foam precursor composition described herein and an expansion gas (e.g., entrained therein).

The expansion gas can comprise any suitable gas or propellant. In some embodiments, the expansion gas comprises nitrogen, CO₂, air, or any combination thereof. The expansion gas can be provided by a prepackaged liquid propellant (liquefied gas propellant) or gas propellant (e.g., a compressed gas present in a gas cylinder), as well as, for example, ambient air or another gas stream (e.g., compressed via a mechanical process).

In some embodiments, the foam exhibits a density of from 2 lbs/gal to 8 lbs/gal.

In some embodiments, the foam exhibits a foam quality of at least 40%, such as a foam quality of from 60% to 95%.

### Methods of Use

Provided herein are methods that comprise generating a foam from the aqueous foam precursor compositions described herein. The foams described herein can be applied to mitigate phytoplankton growth in a body of water. Accordingly, provided herein are methods for mitigating, inhibiting, and/or eliminating phytoplankton growth in a waterbody. These methods can comprise applying the foam to the waterbody.

In some embodiments, the foam is applied to portions of the waterbody where a phytoplankton bloom is present.

In some embodiments, the method further comprises examining the waterbody to determine the extent of phytoplankton growth in the waterbody.

In some embodiments, the method further comprises examining the waterbody to determine the extent of a phytoplankton bloom in the waterbody.

In some embodiments, the method further comprises identifying areas within the waterbody having a toxic phytoplankton biomass above 8,000 cells/mL or a chlorophyll concentration above 3 mg/L. In some embodiments, the method further comprises applying the foam of any one of claims 44-48 to the areas within the waterbody identified as having a toxic phytoplankton biomass above 8,000 cells/mL or a chlorophyll a concentration above 3 mg/L.

In some embodiments, the method further comprises generating the aqueous based foam from an aqueous foam precursor composition described herein and an expansion gas. The aqueous-based foam can be generated from the aqueous foam precursor composition using any suitable means, such as a foam generator. The foam generator can comprise any suitable apparatus known conventionally for generating foams. In some examples, the foam generator can include an in-line mixer and a mesh screen configured in series. The in-line mixer can be, for example, a static mixer, which can receive the aqueous foam precursor solution and the expansion gas and mix the two. The mixture can then pass through one or more mesh screens positioned downstream of the fluid outlet of the in-line mixer. The resulting assembly can effectively shear the aqueous foam precursor in the presence of the expansion gas to form an aqueous-based foam. If desired, the dimensions (e.g., the mesh size) of the one or more mesh screens can be varied to influence characteristics of the foam produced by the foam generator. Alternatively, the foam generator can comprise one or more nozzles or ports which inject the expansion gas into the aqueous foam precursor to form a foam. Alternatively, the foam generator can comprise a dynamic mixer to mechanically agitate (e.g., a mechanically stir, shake, vortex, sonicate, and the like) the aqueous foam precursor in the presence of the expansion gas to form a foam.

In some embodiments, generating the aqueous-based foam comprises: shearing the aqueous foam precursor composition in the presence of the expansion gas; injecting the expansion gas into the aqueous foam precursor composition; or any combination thereof.

The aqueous-based foam can be applied by aerial dispersal, shipboard dispersal, or even by hand. Use of aerial dispersal may be preferred in remote areas where ships may take days or weeks to respond to a phytoplankton bloom. However, the use of ships may be preferred where large quantities of the aqueous-based foam need to be used. In some examples, the foam may be applied from a boat, a plane, a helicopter, a drone, a balloon, or from shore. In any of these examples, the foam may be sprayed.

Dispersal over wide areas may be accomplished with equipment similar to that used for dispersing flame retardants or fertilizer.

In some examples, the phytoplankton comprises cyanobacteria, microalgae, or a combination thereof. In certain examples, the phytoplankton comprises Microcystis sp., Nodularia sp., Cylindrospermopsis sp., Lyngbya sp., Planktothrix sp., Oscillatoria sp., Schizothrix sp., Anabaena sp., Pseudanabaena sp., Aphanizomenon sp., Umezakia sp., Nostoc sp., Spirulina sp., Karenia sp., Gymnodinium sp., dinoflagellates, Prymnesium sp., or any combination thereof.

The present invention is not to be limited in scope by the specific embodiments described which are intended as single illustrations of individual aspects of the invention, and functionally equivalent methods and components are within the scope of the invention. Indeed, various modifications of the invention, in addition to those shown and described herein, will become apparent to those skilled in the art from the foregoing description and accompanying drawings using no more than routine experimentation. Such modifications and equivalents are intended to fall within the scope of the appended claims.

The examples below are intended to further illustrate certain aspects of the compositions and methods described herein and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

The following standard test methods were utilized to characterize materials and compositions described herein.

### Example 1. Foams Loaded with Algicide to Mitigate Algal Blooms of Karenia brevis

### Summary

Harmful algal blooms (HABs) pose significant challenges to coastal communities and economies worldwide. The annual occurrence of the “red tide” along the Gulf of Mexico is caused by Karenia brevis (KB) during periods of eutrophication. Karenia brevis produces brevetoxins that harm marine life and cause illnesses in humans. We describe a new technology utilizing surfactant foams for HAB mitigation. The foams are generated using biodegradable Tween 80, delivering algicides directly to the air-water interface and targeting KB cells with minimum impact on other organisms. We investigated two classes of algicides: water-soluble gallic acid and particulate calcium peroxide (CaO₂), both of which produce hydrogen peroxide, an effective algicide for algal mitigation. Gallic acid foams showed significant KB cell death within 6 hours at 5 mg/mL in the foam formulation, while CaO₂ foams demonstrated rapid and complete cell removal within 6 hours at 1.66 mg/mL in the. foam formulation The flocculant polyaluminum chloride (PAC) integrates easily into the foams and when delivered through the foam, shows flocculation and settling of KB cells. Finally, the combination of PAC and CaO₂ in foams shows targeted destruction where the particulate algicide is incorporated in the flocs and targets KB in the floc. These findings highlight the potential of surfactant foams as a versatile and effective delivery system for mitigating harmful algal blooms

### Introduction

The occurrence of harmful algal blooms (HABs) poses significant challenges to coastal communities and economies worldwide. For example, the colloquially termed “red tide” of the species Karenia brevis (KB) is observed annually during periods of eutrophication and is especially prevalent along coastlines along the Gulf of Mexico. The severity of such HAB occurrences have increased dramatically over the last few decades. Karenia brevis is a marine dinoflagellate that produces brevetoxins that cause significant damage to fish and other marine life. Additionally, such toxins have been found in marine aerosols and are thought to lead to respiratory illnesses in humans living in coastal communities.

The mitigation of marine HABs is therefore important to the health and economy of coastal regions. There are several chemical and biological methods of mitigation described in the literature. Of particular significance are flocculation and settling technologies where a cationic compound such as polyaluminum chloride is mixed with modified clays to flocculate the anionic KB cells and sink them. The organism is thus deprived of sunlight and loses viability due to disruption of photosynthetic pathways. Recent advances in flocculation and settling technologies include the integration of a benign algicide into the floc for targeted destruction of KB.

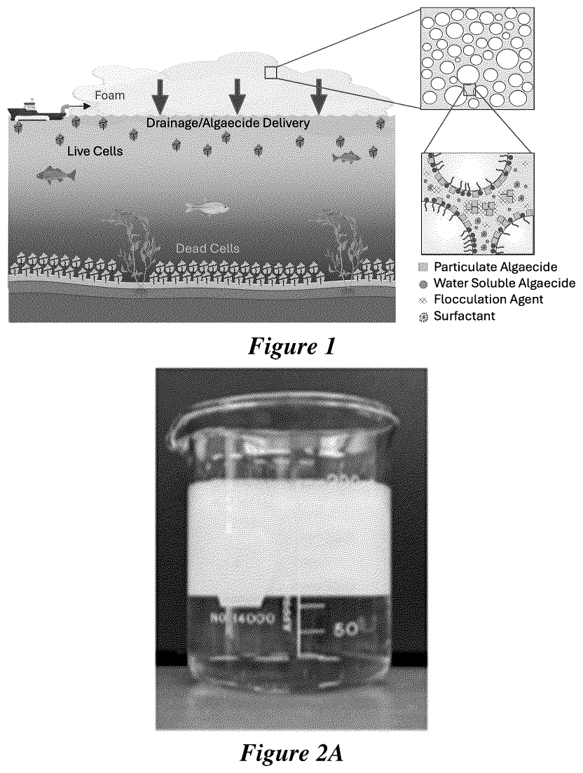

We describe in this Example new compositions and methods to treat harmful algae based on the delivery of algicide-containing surfactant foams to the air-water interface. FIG. 1 illustrates the overall concept of delivering surfactant foams to the surface of the water column. A surfactant foam in the context of this application, is a non-equilibrium colloidal system where air is dispersed in water as discrete air bubbles stabilized against coalescence by surfactants at the bubble-water interface. In typical foams, the bubbles are initially spherical and the microaqueous phase which can constitute less than 10% of the initial foam volume fraction, is sustained through capillary forces.

Upon foam delivery, gravity leads to drainage of the microaqueous phase, and the bubbles come closer into contact taking on a tessellated polyhedral shape. Bubble coalescence subsequently occurs, leading to a gradual dissipation of the foams. There are two timescales involved, the drainage which takes place over a few minutes and can be modified through increasing the viscosity of the microaqueous phase, and bubble coalescence leading to foam dissipation over the course of a few hours. Foam stability can be enhanced through increasing surfactant concentration or through the addition of particulates to inhibit bubble coalescence (Pickering foams).

To the best of our knowledge, the use of foams to deliver algicide to harmful algal blooms has not been described previously. Foams offer a promising approach for algae mitigation and some of their potential advantages are listed below.

1. When algicide from algicide-loaded foams drains out of the foams, the algicide is delivered directly to the water surface as shown in FIG. 1. Algae located close to the surface are thus primarily affected, and the algicide quickly becomes diluted further down into the water column without affecting organisms that are lower down in the water column.

2. There is a uniform delivery of algicide over the cross section of the foam and therefore over the water surface. If we assume that the microaqeuous phase areal fraction is the same as its volume fraction, the areal coverage of the foam could be up to an order of magnitude greater than just the microaqeuous phase areal fraction in the foam.

3. The foam can be loaded with multiple algicides that are either soluble in water or exist as particulates dispersed throughout the foam volume either in the microaqueous phase or at the bubble-water interface.

4. High concentrations of algicide can be incorporated into the foam to maximize effectiveness and target algae that migrate to the surface for exposure to sunlight.

5. Since most of the volume of a foam is air, foams can be generated on site leveraging existing technologies for large scale foam applications, such as in firefighting. The volume of algicide and surfactant solutions that need to be transported is therefore small.

6. The visible trace left by the foam allows for easy identification of treated areas, making reapplication straightforward if needed.

We demonstrate in this Example the capability of foams as a carrier for the delivery of algicide to mitigate Karenia brevis in a laboratory setting. We used a nonionic surfactant, Tween 80 (polyoxyethylene (20) sorbitan monoleate) in foam generation. Due to the sorbitan based headgroup, Tween 80 is biodegradable and is considered environmentally benign. It is an essential component of the COREXIT class of dispersants used in marine oil spill remediation. Tween 80 also is extensively used in pharmaceuticals, foods, and cosmetics products.

To illustrate the versatility of algicide delivery through foams, we have used both a water soluble and inexpensive natural polyphenolic (gallic acid) and a particulate algicide (CaO₂) both of which generate hydrogen peroxide when contacted with water. H₂O₂ typically is a well-accepted algicide which penetrates through cell membranes and reacts with intracellular iron to form reactive oxygen species (ROS) that lead to DNA oxidation and loss of cell viability. In addition to simply delivering algicide from foams, we have sought to integrate flocculation and sinking agents in the foam to take advantage of the areal uniformity in drainage from foams. Thus, we have loaded foams with poly-aluminum chloride (PAC), a cationic flocculant that has been widely studied in HABs flocculation together with kaolinite to accelerate setting of flocs. We have also carried out a study where the particulate algicide (CaO₂) is integrated in foams together with PAC. These concepts of integrating particulates in the microaqueous water channels together with the flocculating agent (PAC) ensure that the particulates are also trapped in the flocs as they are delivered to the water surface where they can entrap cells leading to a new concept in the technology of flocculation and sinking of harmful algae. The results of these experiments point to the potential versatility of foams as delivery agents to mitigate harmful algae.

### Materials and Methods

All chemicals were purchased from Sigma-Aldrich unless otherwise specified. Gallic acid monohydrate and calcium peroxide were used as received. Sterile 50 mL Falcon Tubes (Item no. 339653) and SYTOX-Green nucleic acid stain were purchased from THERMO SCIENTIFIC. An initial culture of Karena brevis (CCMP 2228) was obtained from the Mote Marine Laboratory, Sarasota, Florida, USA. Karenia brevis cells were grown and maintained in modified L1 media (+NH₁₅ vitamins) at ˜24° C. prepared from sterile natural seawater. Cell cultures were maintained under a 12-hour light and 12-hour dark regime at 25° C. in an incubator under fluorescent lighting (˜50-80 μmol photons m⁻² s⁻¹).

Foam Generation. The foams were generated using a commercially available aquarium air pump (Zhiyang Corp. ZY-718) with an aquarium air stone. The air stone was inserted into a 125 ml filter flask containing the surfactant (Tween-80), and the algicide (gallic acid or calcium peroxide) at the required concentrations in the foam liquid phase. After inserting the air stone in the filtering flask, the neck was tightly sealed using ParaFilm M, allowing the foam to only come out through the side arm. Silicone tubing attached to the side arm allowed the foam to be transferred into a volumetric flask containing the cell suspension thus delivering the foam to the top of the cell suspension.

Optical Microscopy. All optical micrographs were obtained using a Nikon Eclipse TE2000-U inverted microscope. 4× and 10× objective lenses were used to image the microstructure of bubbles in the foams. A two-well concave microscope slide covered with No. 1 cover slips were used to keep the foam microstructure intact while acquiring optical micrographs.

Viability Experiments. All viability experiments were conducted using 100 mL sterilized volumetric flasks, each containing KB cells suspended in 100 mL of modified L1 media (+NH15 vitamins) with an initial cell count ranging from 2000 to 4000 cells/ml in the exponential growth phase. Stock solutions of the treatments were freshly prepared using milli-Q water. After the addition of treatment, the flasks were maintained in an incubator under a 12:12 day/night cycle and viability of cells was assessed at fixed time points. The counting of morphologically intact cells was performed using a Sedgwick-Rafter counting chamber after introducing 15 μl of Lugol's Iodine solution to 1 ml of cells suspensions. Prior to withdrawing samples for cell count, each treatment was gently stirred to resuspend the cells and to ensure a representative cell density within the culture. Cells within 120 grids were systematically tallied across 6 vertical columns for cell density quantification.

SYTOX-Green Assay. The effects of treatments on the cells were also investigated utilizing the SYTOX-green assay, a technique designed to evaluate cell-membrane integrity. The SYTOX-green dye selectively permeates through compromised cell membranes and produces green-fluorescent color upon interaction with nucleic acid. It is important to note that SYTOX-green dye does not label lysed cells. For the assay protocol, a 1.0 ml aliquot of the cell suspension was incubated with 10 μl of the dye solution (50 mM) for 15 minutes in the dark, resulting in a final dye concentration of 0.5 mM. The dye concentration and the incubation time were validated by the heat-treated K. brevis cells for 1 h at 60° C. The cell suspension was then transferred in an optically clear well plate for visualization under an inverted fluorescence microscope (Ex: 465-495 nm; Em: 515 nm, long pass).

### Results and Discussion

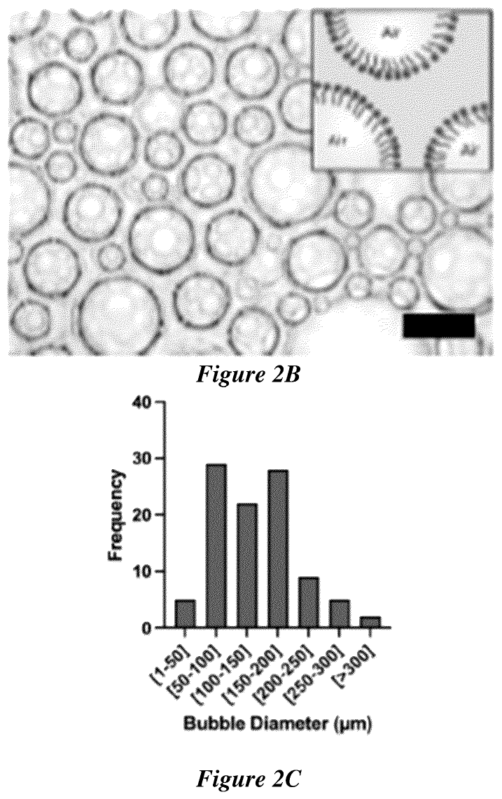

Foam Characterization. The foams were generated using a nonionic, biodegradable surfactant Tween 80 (polyoxyethylene (80) sorbitan monoleate). The biodegradability of Tween 80 through enzymatic hydrolysis of the ester bond, and microorganism uptake of the sorbitan moieties is intrinsic to the use of Tween as a foaming agent in this application to algal cell mitigation, and the surfactant is used extensively in cosmetics, pharmaceuticals, and food products. Foams used in this Example were simply generated using an aquarium air pump where an air stone is inserted into a surfactant solution and bubbles generated by blowing air through the air stone fritted pore structure led to foam formation. FIG. 2A shows an optical image of a foam generated from a stock solution containing 1 wt % Tween 80. The optical micgrograph shown in FIG. 2B indicates a broad size distribution of bubbles with a percolating network of the microaqueous phase. The inset to FIG. 2B is a schematic of foam microstructure to illustrate the partitioning of surfactant molecules at the air-water interface and indicate the microaqueous phase. We note the polydispersity of bubble size with the initial distribution of bubble sizes as shown in FIG. 2C, as obtained through Image J analysis of multiple micrographs. Statistical analysis was done on 100 bubbles in the micrographs, and the average bubble diameter was found to be 143.6 μm with standard deviation 68.55 μm.

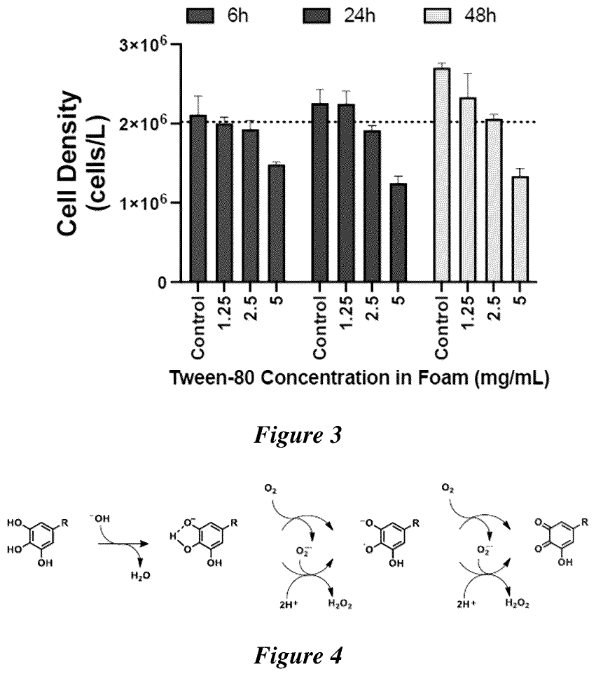

Impact of Tween-80 Concentration on the Viability of KB. In principle, surfactants interact with cell membranes and at high concentrations tend to lyse cells. KB is an athecate dinoflagellate and lacks cellulosic armor in the outer membrane. KB cells are therefore fragile and lyse easily. This fragility leading to membrane rupture and the disruption of cellular integrity under stress conditions, contributes to the release of brevetoxins. Accordingly, we have tried to determine the concentration range of Tween 80 that does not impact KB cell viability. FIG. 3 shows the impact of different Tween 80 concentrations on the viability of KB at 6, 24, and 48 hours after the foams were added to cells. The concentrations listed in FIG. 3 are concentrations in the foam and are reduced when the foam dissipates into the bulk. Thus, the concentrations of 1.25, 2.5 and 5 mg/mL in the foam (based on the liquid precursor from which the foam is generated) translate to 9.37 mg/L, 18.75 mg/L, and 37.5 mg/L in the final solution after full dissipation of the foam. The density of KB in cultures used for viability studies was kept in the 2-3 million cells per liter range, and the cells were in the exponential growth phase. We note that at the concentration of 5 mg/mL in the foam, there is a reduction in viability of about (60%) in 6 hours, but a rebound is observed at later time points. Tween 80 did not have any significant impact on the viability of cells at lower concentrations. The control, and the sample with the lowest concentration of Tween 80 showed the growth of cells during the time of experiment indicating the robustness of cells. The foams used in all the experiments with KB cells were generated from 0.125 wt % stock solutions of Tween 80 in DI water to ascertain retention of cell viability. In large scale applications of foam delivery, we expect a much higher level of dilution of Tween 80 in the water column. Although not the focus of this work, we find that fresh-water HABs such as Microcystis aeruginosa, are able to tolerate 1 wt % Tween 80 and higher with no effect on cell viability.

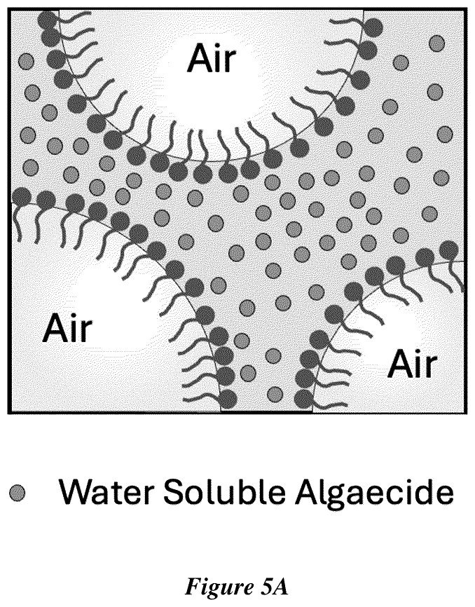

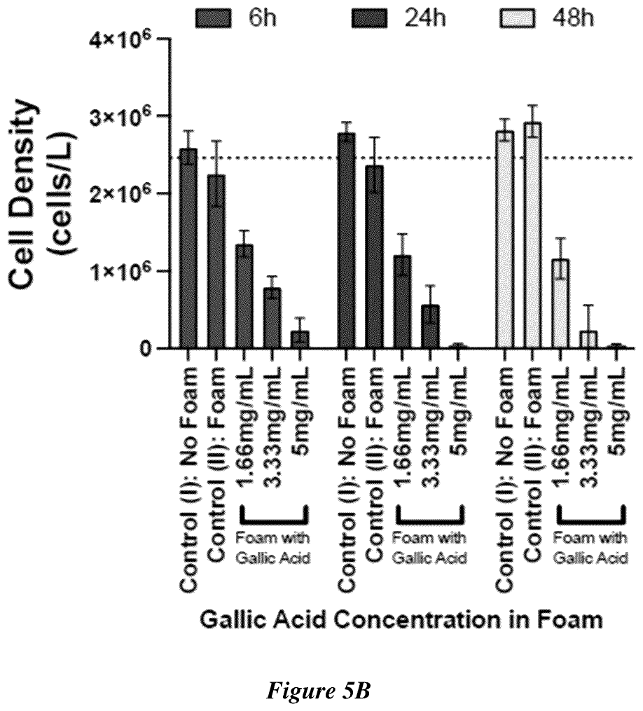

Application of Gallic Acid and CaO₂ as Algicides. Polyphenolic compounds such as gallic acid generate hydrogen peroxide through the mechanism shown in FIG. 4. Gallic acid is highly water soluble and we expect it to be dissolved in the microaqueous channels of the foam. FIG. 5A is a schematic of the microaqeuous channels containing dissolved gallic acid. Three doses of gallic acid (1.66 mg/mL, 3.33 mg/mL, 5 mg/mL in the foam) were selected for incorporation in the foam. The corresponding concentrations in the bulk solution after delivery are 12.5 mg/1, 25 mg/l, and 37.5 mg/l, respectively.

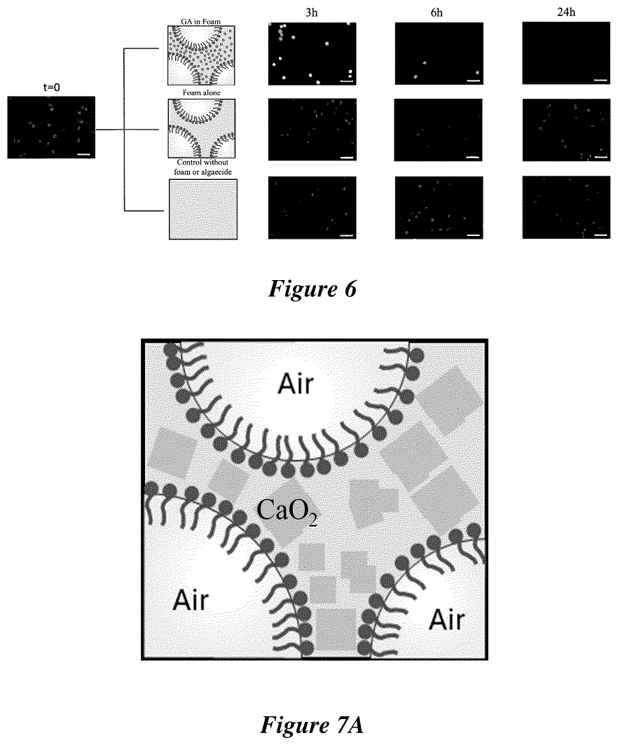

Cell viability was assessed at 6, 24 and 48 hours, respectively. FIG. 5B shows the results of treatment. We note that the two control samples, one containing only cells in solution, and one containing cells in solution with a head of algicide free foam, both indicate retention of cell viability and cell growth over the time period of the experiment (48 hours). The results indicate that beyond a concentration of 1.66 mg/mL in the foam, there is a loss of viability with no evidence of a recovery. Upon increase in gallic acid dosage (5 mg/mL), almost complete cell death was achieved within 6 hours, and no recovery was observed after 48 hours. Evaluation of structural integrity of the cell membranes after applying the GA in foam treatment was carried out using the SYTOX-green assay as shown in FIG. 6. The SYTOX-green nucleic acid stain is a green-fluorescent nuclear and chromosome counterstain. Being impermeant to live cells, it a useful indicator of membrane compromised cells within a population with the red fluorescence indicating viable cells and the green fluorescence indicating membrane compromised cells. We conducted the assay for gallic acid treatment which was found to induce a loss of viability within 6 hours. The SYTOX-green data indicate membrane compromised cells even within 3 hours of treatment. An almost total loss of cell green fluorescence is observed in 24 hours indicating lysis. In contrast both control samples show intact fluorescence over the 24-hour period of the experiment indicating retention of viability.

We also evaluated calcium peroxide (CaO₂) as an algicide to be delivered through the foam. CaO₂ is a particulate based algicide and reacts with water to produce H₂O₂ and O₂ through eq. 1 and 2, respectively.

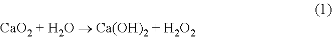

with a slower parallel reaction

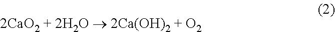

As CaO₂ reacts with water, it produces Ca(OH)₂ which is water insoluble. At acidic pH, the production of H₂O₂ is rapid, while at basic pH values, the reaction rate is significantly reduced. In our recent work we have shown that decomposition of CaO₂ in the naturally buffered marine environment at pH 8 is sufficiently rapid to allow H₂O₂ production to destroy cells. Entry of H₂O₂ into the cell and interaction with intracellular Fe²⁺ produces toxic hydroxyl radicals through the Fenton reaction

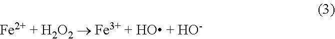

with the hydroxyl radicals leading to DNA oxidation mechanisms and cell death. Additional pathways induced by H₂O₂ lead to other reactive oxygen species (ROS) that create oxidative stress.

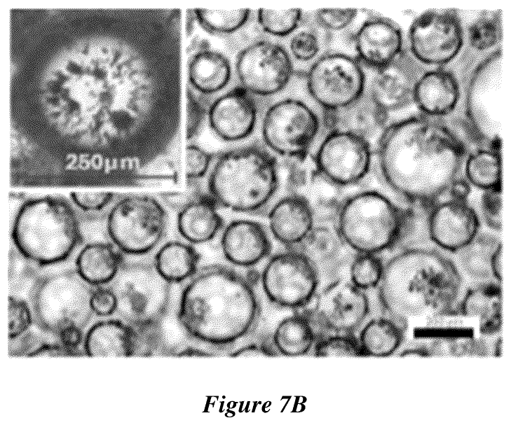

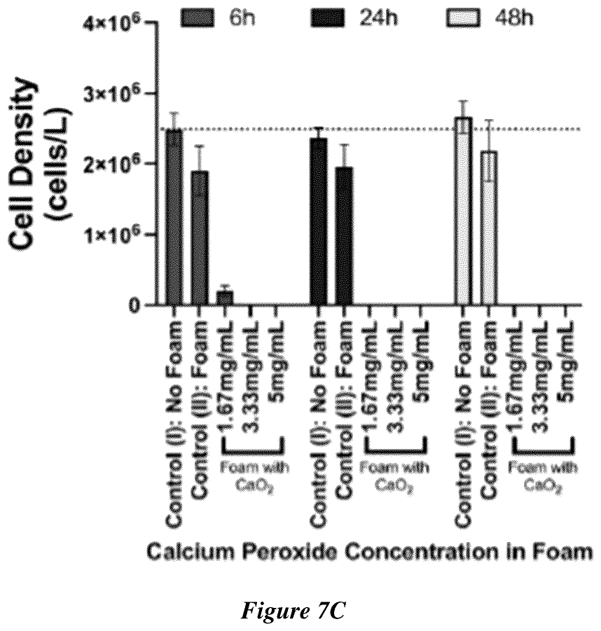

As shown in equations 1 and 2, CaO₂ reacts with water to form calcium hydroxide, a water insoluble compound. We expect the particulate material with aggregate dimension of about 80 μm (200 mesh) to reside in the microaqueous channels of the foam spanning the channel width (approximately 70 μm). FIG. 7A shows the schematic of CaO₂ in the water channels. FIG. 7B is an optical micrograph of a foam loaded with CaO₂. The particles are dispersed on the surface of the bubbles, or form aggregates in the liquid channels. With the level of resolution in the optical micrograph it is difficult to deduce whether these are truly Pickering foams with the particles exclusively at the interface. However, the fact that the particle dimension is of the order of water microchannel width indicates that the particles may stabilize the foam microstructure to some extent. Three doses of calcium peroxide (1.66 mg/mL, 3.33 mg/mL, 5 mg/mL in the foam, corresponding to 12.5 mg/l, 25 mg/l, and 37.5 mg/l in the bulk solution) were selected for incorporation in the foam and the cell viability was assessed at 6, 24 and 48 hours, respectively. Evaluation of cell viability after applying the treatment was carried out using the SYTOX-green assay following the identical protocol to gallic acid. As shown in FIG. 7C, the minimum dose of calcium peroxide (1.66 mg/mL) is effective in cell removal within the first six hours. There is no evidence of a rebound of cell viability in the 48 hour time period.

Flocculation and Sinking of Cells. Poly(aluminum chloride) (PAC) is a highly cationic compound with the chemical formula: [Al₂(OH)ₙCl₆₋ₙ]ₘ(1≤n≤5, m≤10). It is used widely in water purification as a flocculant due to its low cost, and has been studied in HAB mitigation technologies due to its ability to electrostatically bind to the anionic algal cells. In traditional flocculate and sink technologies, modified clays are typically added to PAC. These clay particles that are anionic (due to surface silanol groups) also attach to the PAC and accelerate the sinking process, thus serving as ballast. We have therefore investigated the possibility of loading PAC in foams, to entrap and sink the cells, noting that the water-soluble PAC will be released to the water column through drainage of the microaqueous phase. Again, due to the low volume fraction of water in foams, the areal fraction is also extremely small implying that the drainage will occur over large areas and PAC will be uniformly released over the cross-sectional area covered by the foam.

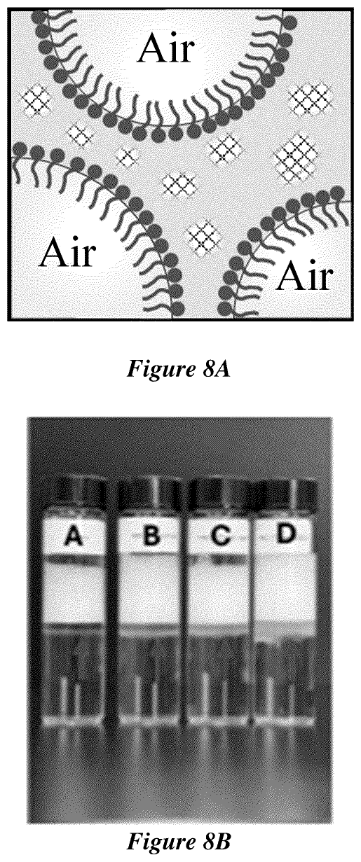

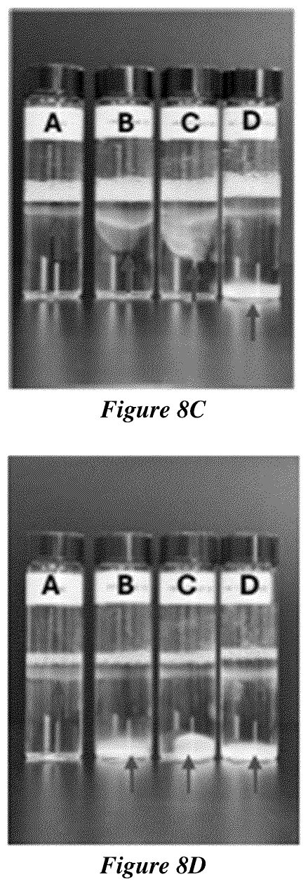

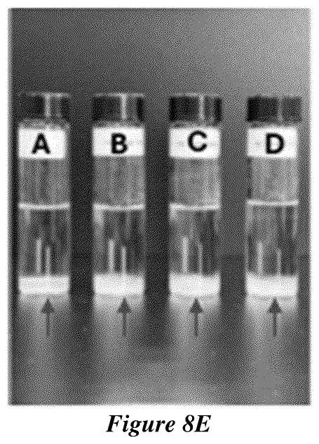

To load PAC in foams, the material was simply added to the foam precursor solution and the foams were generated using the air pump system described in the Materials and Methods section. Since PAC is water soluble, we expect the compound to be sustained in the microaqueous channels of the foam. FIG. 8A is a schematic of the microstructure of foams containing PAC in the microaqueous phase. The photographic images in FIGS. 8B-8E show the concepts of floc formation and settling where we have added kaolinite particles (˜7 μm) at various levels to understand the settling characteristics when this ballast is added. To enhance visualization of the settling, we have worked with a high concentration of PAC in the foam that will lead to a final concentration in the bulk solution of 400 mg/L. The uniformity of PAC drainage across the cross section of the sample vial is visualized as a discrete layer that slowly propagates downwards. Three levels of clay were added to the foam formulation (0.66, 1.33, 2.66 mg/L in the foam stock solution corresponding to concentrations of 50 mg/l, 100 mg/l, and 200 mg/l in the bulk solution after foam dissipation). FIG. 8C shows a basket like appearance of the PAC floc with the incorporation of kaolinite. As shown in FIG. 8B-8E, as the kaolinite level increases, the flocs settle faster, compared to PAC alone. Over the course of 24 hours, all samples showed flocs accumulated on the bottom of the vial and complete dissipation of the foam.

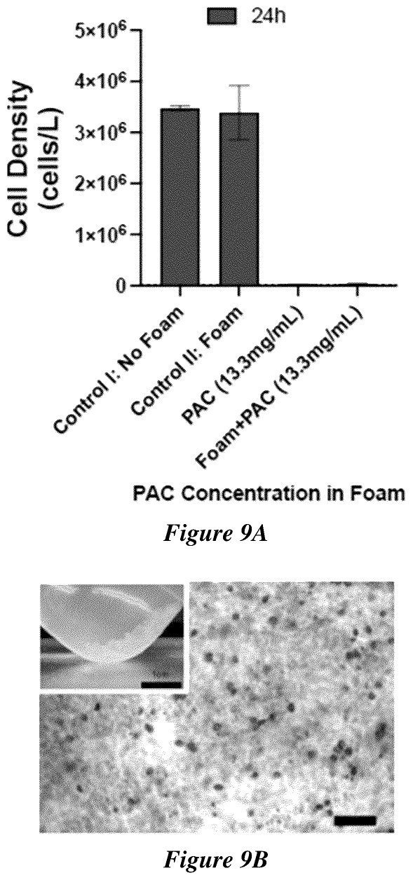

To quantify the impact of foams loaded with PAC on flocculation and settling of KB, foams loaded with PAC were delivered on the surface of a cell suspension maintained in a volumetric flask and cell remaining in suspension were counted after 24 hours. We note that this experiment was done without any kaolinite addition to be able to avoid the difficulty in distinguishing between cells and kaolinite particles in the floc. FIG. 9A illustrates the effectiveness of flocculation and sinking where the delivery of PAC through the foam (at a PAC concentration of 13.3 mg/mL in the foam) is compared to simply injecting an aliquot of the same level of PAC in solution. In both systems the final PAC concentration in the bulk solution is 100 mg/L. The foam method of delivery is as effective as just the injection of PAC and in both methods, there is a complete removal of cells from suspension. FIG. 9B shows the effectiveness of flocculation using the delivery of PAC through a foam, where a sample of the final settled floc was removed and imaged through optical microscopy. We note the high density of cells (the dark dots) in the floc with image analysis showing an areal density of about 80 visible cells over the image (0.02 cm²). The inset to FIG. 9B shows the visible image of a floc with the greenish tinge indicating the presence of cells. Thus, PAC integration in the foams is efficient in creating a thin layer of flocculant that gradually moves downward through the water column encapsulating cells.

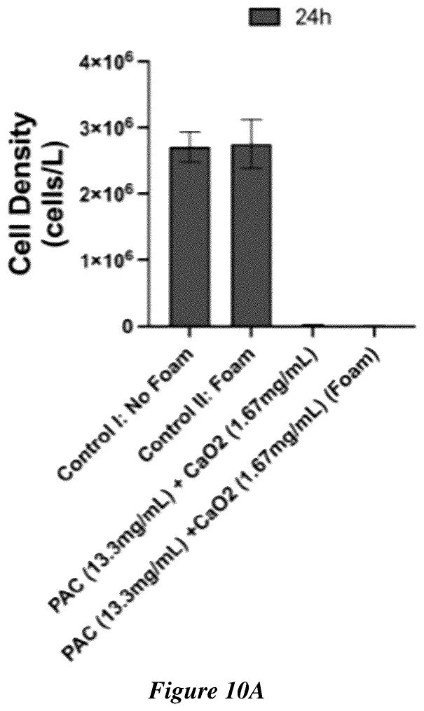

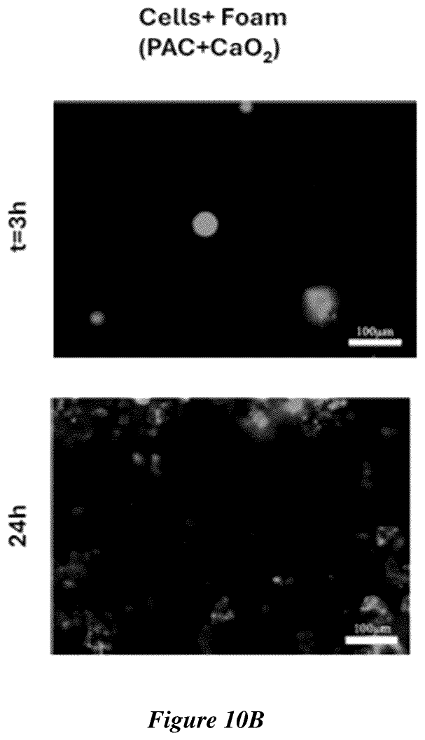

Flocculation and Destruction of Cells within the Flocs. One of the potential advantages of using foams is the fact that multiple agents can be integrated into the foams. As an example, we can combine the flocculation and sinking process to targeted destruction by integrating both PAC and CaO₂ in the foams. FIG. 10A illustrates the results of this experiment and we note that CaO₂ integration into the PAC floc serves as a ballast equivalent to the addition of kaolinite. We considered two controls, one with no foam on the surface of the water and without addition of PAC and CaO₂, and a second control with a foam alone on the surface of the water, but again without addition of PAC and CaO₂. In both controls there is full cell viability in 24 hours. We then compare the results of PAC and CaO₂ delivery both through direct injection and through integration in a foam. Manual cell counting of samples taken from the water column after allowing settling for 24 hours shows a full removal of the cells. We note that the addition of PAC and CaO₂ to both the foam free system and the system with PAC and CaO₂ integrated into the foam are essentially equivalent in removing cells. Results of the SYTOX-green assay are shown in FIG. 10B for the foam delivery system. We note that due to the high concentration of cells in the floc, we can observe the transition from viable cells to compromised cells in as short a time as 3 hours. The results of foam delivery are in agreement with our earlier work on the direct injection of PAC and CaO₂ to flocculate and destroy cells.

### CONCLUSION

We have studied the capability of foams generated from biodegradable surfactant Tween 80 to act as a carrier for delivery of two algaecidal agents and a flocculant to mitigate harmful algal blooms of Karenia brevis. The nonionic, biodegradable surfactant Tween 80 was shown to be effective in generating foams. Integration of algicides (water soluble polyphenols and the particulate CaO₂) and agents for flocculation (PAC) and settling (kaolinite) can be easily integrated into the foam by dispersing the materials into the foam precursor solution and subsequently generating a foam. We note that foam generation on a large scale is technically feasible and is used in a number of firefighting applications as an example. With both algicides, there was an efficient destruction of KB cells and the flocculation and settling studies indicated a uniform layer of flocculant being delivered and gradually settling with entrapped cells. Integration of the algicide CaO₂ and PAC into the foam showed efficient sinking and a targeted destruction of KB cells. The use of a foam allows delivery to the water-air interface that is uniform in areal application.

We thus note the versatility of the foams in delivering algicides and in the development of efficient targeted flocculation and sinking technologies. Integration of algicides into the foams at high concentrations implies targeting the accumulation of harmful algal blooms at the water-air interface with negligible impact on non-target organisms further down the water column. The uniformity of areal delivery can be further exploited through the integration of carbons in the foam to adsorb algal toxins released as algal cells lyse. These technologies both to understand the impact to off-target organisms and to characterize toxin removal are the subjects of continued study. The use of foams offers the potential for large-scale applications in managing harmful algal blooms, providing a biodegradable and efficient solution to maintain water quality and protect marine life and human health.

### REFERENCES

(1) Hoagland, P.; et al. Lessening the Hazards of Florida Red Tides: A Common Sense Approach. Frontiers in Marine Science 2020, 7, Article.
(2) Bechard, A.; Lang, C. The human health effects of harmful algal blooms in Florida: The importance of high resolution data. Harmful Algae 2024, 132, 102584.
(3) Jin, D.; Moore, S.; et al. Evaluating the Economic Impacts of Harmful Algal Blooms: Issues, Methods, and Examples. PICES Scientific Report 2020, (59), 5-41.
(4) Morgan, K. L.; et al. Firm-level economic effects of HABS: A tool for business loss assessment. Harmful Algae 2009, 8 (2), 212-218.
(5) Anderson, D. M.; et al. Marine harmful algal blooms (HABs) in the United States: History, current status and future trends. Harmful Algae 2021, 102, 101975.
(6) Van Dolah, F. M.; et al. The Florida red tide dinoflagellate Karenia brevis: New insights into cellular and molecular processes underlying bloom dynamics. Harmful Algae 2009, 8 (4), 562-572.
(7) Pierce, R. H.; et al. Harmful algal toxins of the Florida red tide (Karenia brevis): natural chemical stressors in South Florida coastal ecosystems. Ecotoxicology 2008, 17 (7), 623-631.
(8) Daugbjerg, N.; et al. Phylogeny of some of the major genera of dinoflagellates based on ultrastructure and partial LSU rDNA sequence data, including the erection of three new genera of unarmoured dinoflagellates. Phycologia 2000, 39 (4), 302-317.
(9) Pierce, R. H.; et al. Brevetoxin composition in water and marine aerosol along a Florida beach: Assessing potential human exposure to marine biotoxins. Harmful Algae 2005, 4 (6), 965-972.
(10) Plakas, S. M.; et al. Confirmation of brevetoxin metabolism in the Eastern oyster (Crassostrea virginica) by controlled exposures to pure toxins and to Karenia brevis cultures. Toxicon 2002, 40 (6), 721-729.
(11) Lim, C. C.; et al. Harmful algal bloom aerosols and human health. EBioMedicine 2023, 93.
(12) Hoagland, P.; et al. The costs of respiratory illnesses arising from Florida Gulf Coast Karenia brevis blooms. Environmental Health Perspectives 2009, 117 (8), 1239-1243.
(13) Fleming, L. E.; et al. Initial evaluation of the effects of aerosolized Florida red tide toxins (brevetoxins) in persons with asthma. Environmental Health Perspectives 2005, 113 (5), 650-657.
(14) Rounsefell, G. A.; et al. Large-scale experimental test of copper sulfate as a control for the Florida red tide; US Department of the Interior, Fish and Wildlife Service, 1958.
(15) Marvin, K. T.; et al. Effects of copper ore on the ecology of a lagoon; 1961.
(16) Marvin, K. T.; et al. Preliminary results of the systematic screening of 4306 compounds as Red-tide toxicants. 1964.
(17) Marvin, K. T.; et al. LABORATORY EVALUATION OF RED-TIDE CONTROL AGENTS. Fishery Bulletin of the Fish and Wildlife Service 1967, 66 (1), 163.
(18) Blogoslawski, W.; Thurberg, F.; Dawson, M. Ozone inactivation of a Gymnodinium breve toxin. Water Research 1973, 7 (11), 1701-1703.
(19) Blogoslawski, W.; et al. Field studies on ozone inactivation of a Gymnodinium breve toxin. Environmental Letters 1975, 9 (2), 209-215.
(20) Schneider, K.; et al. The use of ozone to degrade Gymnodinium breve toxins. In 2. Conference Internationale sur la Purification des Coquillages, Rennes (France), 6-8 Apr. 1992, 1992.
(21) Schneider, K. R.; et al. The degradation of Karenia brevis toxins utilizing ozonated seawater. Harmful Algae 2003, 2 (2), 101-107.
(22) Gonzalez Gomez, A.; et al. Liposomes for Antibiotic Encapsulation and Delivery. ACS Infect Dis 2020, 6 (5), 896-908.
(23) Doucette, G. J.; et al. Algicidal bacteria active against Gymnodinium breve (Dinophyceae). I. Bacterial isolation and characterization of killing activity. Journal of Phycology 1999, 35 (6), 1447-1454.
(24) Imai, I. Algicidal ranges in killer bacteria of direct attack type for marine phytoplankton. Bulletin of Plankton Society of Japan (Japan) 1997, 44 (1).
(25) SENGCO, M. R.; et al. Controlling Harmful Algal Blooms Through Clay Flocculation1. Journal of Eukaryotic Microbiology 2004, 51 (2), 169-172.
(26) Li, L.; et al. A Universal Method for Flocculating Harmful Algal Blooms in Marine and Fresh Waters Using Modified Sand. Environmental Science & Technology 2013, 47 (9), 4555-4562.
(27) Seger, A.; et al. Application of clay minerals to remove extracellular ichthyotoxins produced by the dinoflagellates Karlodinium veneficum and Karenia mikimotoi. Harmful Algae 2022, 111, 102151.
(28) Yu, Z.; et al. Flocculation and removal of the brown tide organism, Aureococcus anophagefferens (Chrysophyceae), using clays. Journal of Applied Phycology 2004, 16 (2), 101-110.
(29) Lewis, M. A.; et al. Toxicity of clay flocculation of the toxic dinoflagellate, Karenia brevis, to estuarine invertebrates and fish. Harmful Algae 2003, 2 (4), 235-246.
(30) Sengco, M. R. Prevention and control of Karenia brevis blooms. Harmful Algae 2009, 8 (4), 623-628.
(31) Pierce, R. H.; et al. Removal of harmful algal cells (Karenia brevis) and toxins from seawater culture by clay flocculation. Harmful Algae 2004, 3 (2), 141-148.
(32) Hossain, I.; et al. An effective algaecide for the targeted destruction of Karenia brevis. Harmful Algae 2024, 138, 102707.
(33) Weaire, D. L.; et al. The physics of foams; Oxford University Press, 1999.
(34) Hunter, T. N.; et al. The role of particles in stabilising foams and emulsions. Advances in colloid and interface science 2008, 137 (2), 57-81.
(35) Dickinson, E. Food emulsions and foams: Stabilization by particles. Current Opinion in Colloid & Interface Science 2010, 15 (1-2), 40-49.
(36) Lee, S.; et al. Selective biodegradation of sorbitan ethoxylated surfactants by soil microorganisms. International Biodeterioration & Biodegradation 2013, 85, 652-660.
(37) Hayes, D. G. Chapter 11-Fatty Acids-Based Surfactants and Their Uses. In Fatty Acids, Ahmad, M. U. Ed.; AOCS Press, 2017; pp 355-384.
(38) Athas, J. C.; et al. An effective dispersant for oil spills based on food-grade amphiphiles. Langmuir 2014, 30 (31), 9285-9294.
(39) Bekhit, M.; et al. Radiation-induced synthesis of tween 80 stabilized silver nanoparticles for antibacterial applications. Journal of Environmental Science and Health, Part A 2020, 55 (10), 1210-1217.
(40) Wang, W.; et al. Dual effects of Tween 80 on protein stability. International Journal of Pharmaceutics 2008, 347 (1), 31-38.
(41) van Aken, G. A.; et al. Differences in in vitro gastric behaviour between homogenized milk and emulsions stabilised by Tween 80, whey protein, or whey protein and caseinate. Food Hydrocolloids 2011, 25 (4), 781-788.
(42) Mahaseth, T.; et al. Potentiation of hydrogen peroxide toxicity: From catalase inhibition to stable DNA-iron complexes. Mutat Res Rev Mutat Res 2017, 773, 274-281.
(43) Pan, G.; et al. Modified local sands for the mitigation of harmful algal blooms. Harmful Algae 2011, 10 (4), 381-387.
(44) Fleming, L. E.; et al. Overview of aerosolized Florida red tide toxins: exposures and effects. Environ Health Perspect 2005, 113 (5), 618-620.
(45) Novoveská, L.; et al. Brevetoxin-Producing Spherical Cells Present in Karenia brevis Bloom: Evidence of Morphological Plasticity? Journal of Marine Science and Engineering 2019, 7 (2), 24.
(46) Gao, Y.; et al. Insights into Stress-Induced Death Processes during Aging in the Marine Bloom-Forming Dinoflagellate Karenia brevis. Journal of Marine Science and Engineering 2022, 10 (12), 1993.
(47) Twiner, M. J.; et al. Extraction and analysis of lipophilic brevetoxins from the red tide dinoflagellate Karenia brevis. Analytical Biochemistry 2007, 369 (1), 128-135.
(48) Akagawa, M.; et al. Production of hydrogen peroxide by polyphenols and polyphenol-rich beverages under quasi-physiological conditions. Bioscience, biotechnology, and biochemistry 2003, 67 (12), 2632-2640.
(49) Cao, G.; et al. Antioxidant and prooxidant behavior of flavonoids: structure-activity relationships. Free Radic Biol Med 1997, 22 (5), 749-760.
(50) Wang, H. F.; et al. Properties of calcium peroxide for release of hydrogen peroxide and oxygen: A kinetics study. Chem Eng J 2016, 303, 450-457.
(51) Keliri, E.; et al. Calcium peroxide (CaO₂) granules enclosed in fabrics as an alternative H₂O₂ delivery system to combat Microcystis sp. Chemical Engineering Journal Advances 2022, 11, 100318.
(52) Kansole, M. M.; et al. Impacts of Hydrogen Peroxide and Copper Sulfate on the Control of Microcystis aeruginosa and MC-LR and the Inhibition of MC-LR Degrading Bacterium Bacillus sp. Water 2017, 9 (4), 255.
(53) Ransy, C.; et al. Use of H₂O₂ to cause oxidative stress, the catalase issue. International journal of molecular sciences 2020, 21 (23), 9149.
(54) Liu, Y.; et al. Flocculation of harmful algal cells using modified clay: effects of the properties of the clay suspension. Journal of Applied Phycology 2016, 28, 1623-1633.
(55) Noyma, N. P.; et al. Controlling cyanobacterial blooms through effective flocculation and sedimentation with combined use of flocculants and phosphorus adsorbing natural soil and modified clay. Water Research 2016, 97, 26-38.
(56) Vinogradov, A. V.; et al. Silica Foams for Fire Prevention and Firefighting. ACS Applied Materials & Interfaces 2016, 8 (1), 294-301.
(57) Sheng, Y.; et al. Study of environmental-friendly firefighting foam based on the mixture of hydrocarbon and silicone surfactants. Fire Technology 2020, 56, 1059-1075

### Example 2. Large Molecular Weight Polyphenol Based Materials to Flocculate Harmful Algal Blooms

Flocculation and sedimentation technologies are considered amongst the most promising in the mitigation of harmful algal blooms. Effective technologies include the use of modified clays where the modification is through the use of a highly cationic compound, polyaluminum chloride (PAC) which binds electrostatically to anionic clays such as kaolinite and also to cells which have an anionic surface charge. PAC while a highly efficient flocculant for HABs, is not currently approved for use by the EPA due to environmental concerns about the possible toxic effects of aluminum on invertebrates. Thus, there is therefore, an intense interest in replacing PAC with environmentally benign alternative flocculants that will rapidly find EPA approval either as a minimum risk pesticide component or existing tolerance exemptions. Such an alternative would be useful for multiple existing research efforts at developing flocculation and sedimentation technology for HAB control.

In this Example, we describe efforts to develop an alternative to polyaluminum chloride (PAC) in technologies related to the flocculation and sinking of harmful algal blooms (HABS). It is proposed to use tannic acid and chitosan as a combined replacement for PAC in the flocculation and settling of Microcystis Aeruginosa (MC). Tannic acid is approved by EPA as a dispersing agent with no limits in usage. Chitosan is approved through FIFRA 25 (b) and is on the EPA list for minimal risk active ingredients. We also contemplate the incorporation of small amounts of Fe (III) and/or Mg (II) into such systems to form metal phenolic networks (MPNs). Our initial results show the versatility of the MPN-chitosan complex (MPN-CS) in forming flocs with MC and we will further study such complexes and optimize their formulations to be able to deploy a highly effective system (e.g., within a foam for delivery).

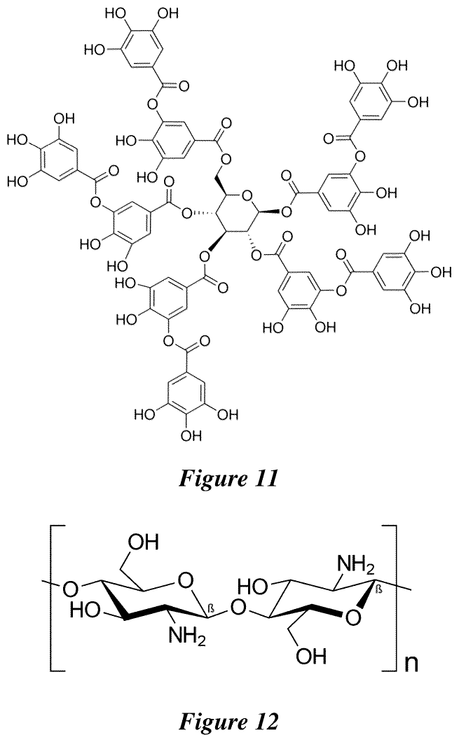

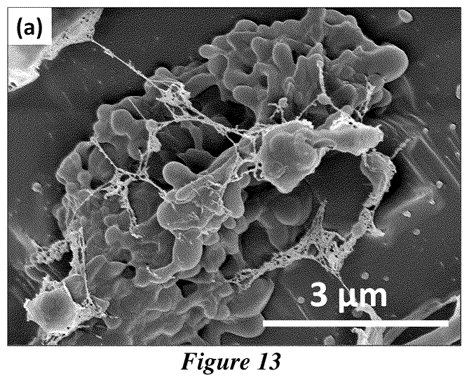

Tannic acid (TA) is a high molecular weight polyphenol (FIG. 11) with a molecular weight of 1701 g/mol. It is a natural polyphenol found in plants and is generally regarded as safe (GRAS) by the FDA and can be obtained in large quantities. The multiple hydroxyl groups of TA confer bioadhesive properties to the molecule in analogy to the catechol based proteins responsible for the underwater adhesive properties of mollusks. Polyphenolics such as tannic acid can bridge lipid bilayers. FIG. 13 shows a cryo SEM with liposomes as cell mimics, indicating that such binding results in floc formation and a gluing of the vesicles. Chitosan (CS) is a polysaccharide with glucosamine groups imparting a cationic charge to the molecule (FIG. 12). Hydrogen bonding between the amine groups of chitosan and tannic acid hydroxyl moieties leads to a complex. Additionally, the cationic chitosan binds to anionic cells through electrostatic interactions. Multiple hydrogen bonding interactions of the hydroxyl groups of TA to cell membranes leads to further binding of cells with TA-CS complexes. Thus, there are both hydrogen bonding (to TA) and electrostatic interactions (with CS) leading to cell flocculation in tannic acid-chitosan complexes.

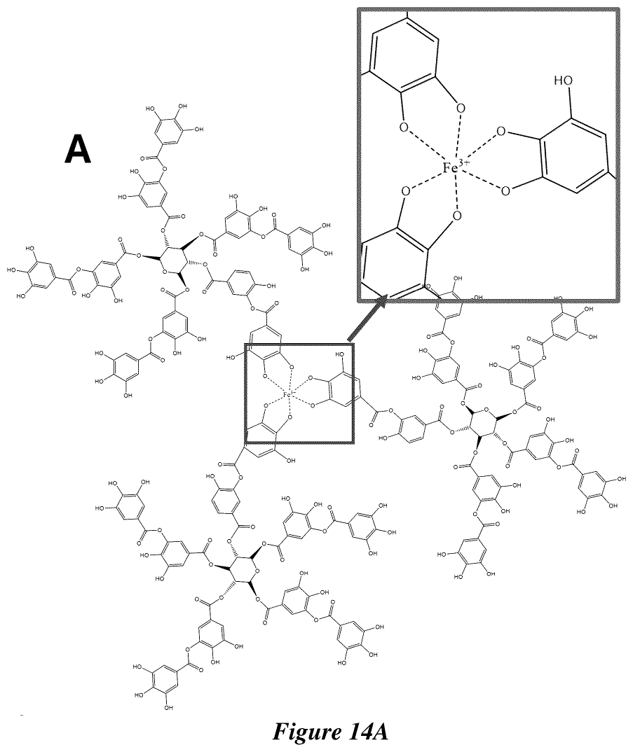

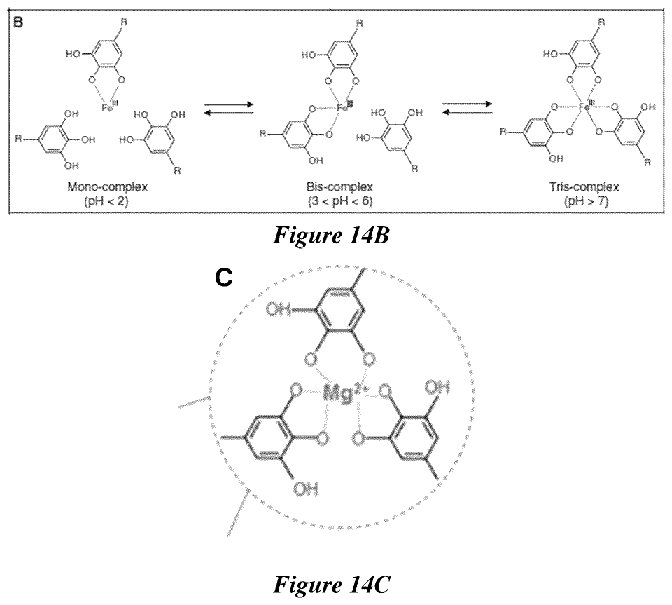

We have also evaluated the use of metal-phenolic networks where a small amount of Fe(III) of Mg(II) is added to tannic acid to form extended complexes. MPNs are composed of a natural occurring polyphenol such as tannic acid (TA), coordinated with a metal ion (Fe³⁺), both of which are intrinsically benign materials. FIGS. 14A-14B illustrate the structure of an MPN formed with Fe(III) (14A) or Mg(II) (14B) and the fact that the complex, while stable at neutral pH values gradually falls apart at acidic pH values. MPNs are fully stable in freshwater systems.

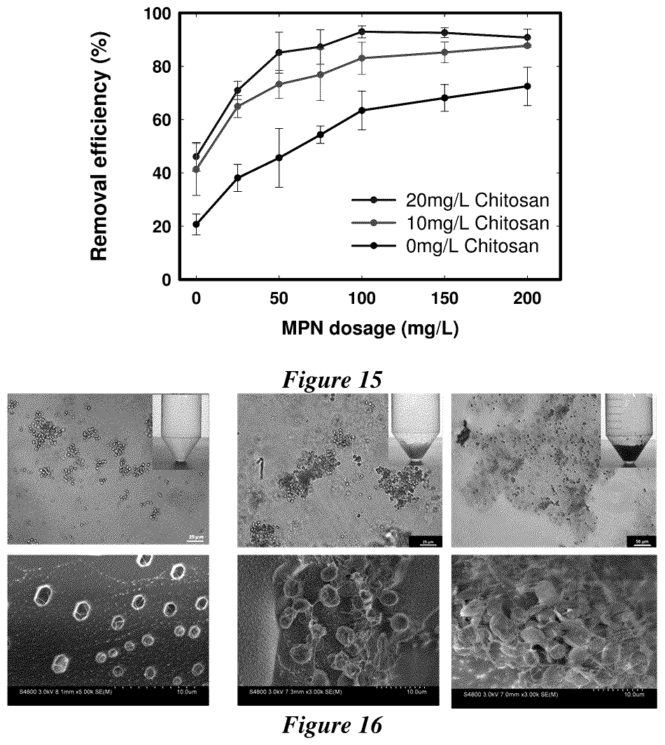

Data indicates that MPNs will efficiently flocculate Karenia brevis (KB) as shown through FIG. 15. FIG. 16 shows initial results with the flocculation of MC, with the top row showing optical micrographs and the bottom row showing cryogenic SEMs which retain the fidelity of the native structure and provide compelling direct evidence of cell entrapment in flocs. The leftmost column represents the control sample of MC in suspension. The center column indicates flocculation with TA and chitosan and strands between cells are clearly seen in the cryo SEMs. The third column shows flocculation and settling with MPNs and chitosan. We see that floc size is significantly increased and the cryo SEMs clearly indicate multiple strands connecting the flocs. In the case of MPNs with CS (MPN-CS) we see a cobweb type structure with interconnecting strands. To the best of our knowledge, these cryo-SEM are the first high resolution images of MC trapped in a flocculation matrix. We also note that the inset photographs show the presence of flocculated cells at the bottom of the sample tube. These flocs stay stable with time and there is no vertical migration of cells observed.

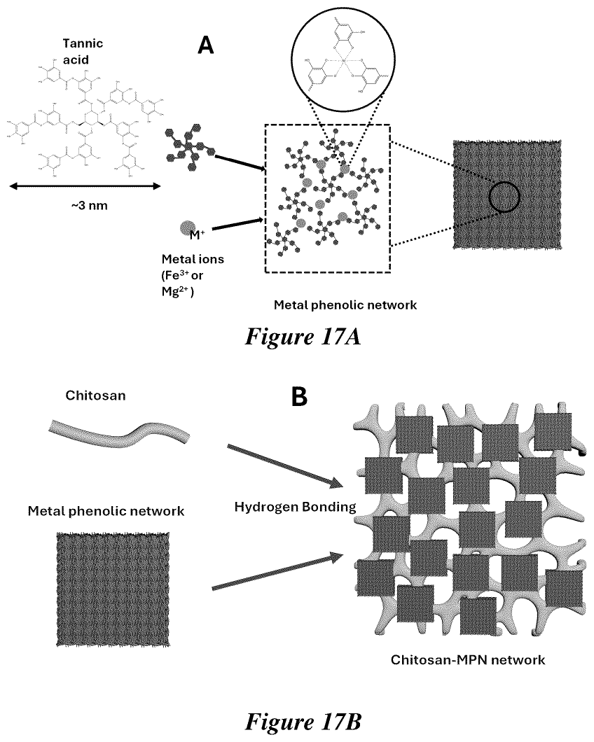

The proposed mechanism behind the formation of the large MPN flocs with chitosan is shown in FIGS. 17A-17B. FIG. 17A represents the formation of MPNs through Fe(III) (or Mg(II)) mediated coordination of tannic acid molecules. FIG. 17B illustrates the attachment of CS with MPNs through hydrogen bonding and the interweaving of CS to form large MPN networks for algal capture.

Tests will be performed to understand the flocculation of MC using chitosan and tannic acid complexes, including testing for cell viability. We will use detailed imaging through optical and electron microscopy, viability testing through flow cytometry, and hemocytometry and chlorophyll measurements. A Thermo Fisher Attune Flow Cytometer will be used for monitoring phycocyanin emission at 645 nm to distinguish live vs dead cells. The loss of phycocyanin from nonviable cells leads to a decrease in the fluorescence signal detected through side scattering. Pulse amplitude modulation (PAM) fluorometry will also be used to measure the photosynthetic efficiency of the cells (Walz PhytoPAM II compact). This is achieved through several complimentary measurements, including maximum quantum yield (Fᵥ/Fₘ, where Fᵥ is the variable fluorescence and Fₘ is maximum fluorescence), electron transport rate (ETR) using rapid light curves, and absorption cross section, using fast kinetics. For the flocculation studies, the integration of clays into the flocs is essential to accelerate settling. Anionic clays such as kaolinite and halloysite bind to the cationic CS and can be easily integrated into the floc.

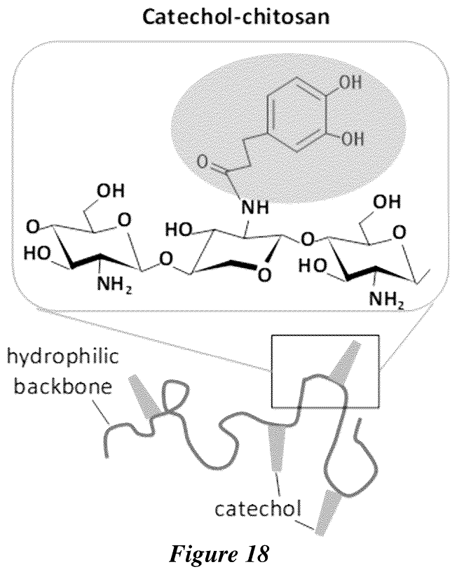

Chitosan has a pKa of 6.5 and at freshwater pH values the biopolymer will aggregate to form precipitates. To minimize aggregation, we solubilize chitosan at pH 6 together with TA thus enhancing hydrogen bonding, preventing aggregation and maintaining solubility after injection in freshwater (dried complexes of CS and TA will be used in application). But a better way may be to use soluble forms of CS. We will attach catechol groups to chitosan through the amine-carboxylic acid linkage as shown in FIG. 18. Similar chemistries can be used to directly couple CS to TA. Such covalent linkage of CS to TA should make the flocs significantly more robust. We will also carry out rheological and mechanical testing of the MPN-CS complexes with characterizations of the shear modulus and the tensile modulus as indicative of the robustness of the material.

ELISA tests will be done where toxin analysis on larger scale systems will be conducted. The integration of carbons to adsorb toxins is straightforward and will be done. If the technology is found viable and we are able to proceed to implementation, we will study toxin generation further using LC/MS facilities.

We will also perform scaled-up studies to assess the efficacy of the material for removal and degradation of cells and toxins. Initial studies will narrow down the concentrations of the material to the most effective range using an 80-L vertical assay system, which can utilize natural bloom water. The vertical orientation of this tank system allows for evaluation of the response of M. aeruginosa cells and toxins to the hybrid material as it flocculates and descends through the 1.2 m water column over time. A fixed-port sampling system allows waters samples to be collected at multiple depths without disturbing the water column. Tanks are illuminated with overhead full spectrum LED lamps (up to ˜800 μmol·m⁻²·s⁻¹ at surface) on a 12:12 light:dark cycle. These studies will include testing for toxins (ELISA) as well as measurements of photosynthetic efficiency (PAM) and cell abundance and morphology (using microscopy and imaging particle analysis (FlowCam)). In carrying out these experiments, we will examine whether vertical migration of MC trapped in flocs is possible. If the flocs are able to suppress vertical migration, it is our hypothesis that the cells will lose viability over time. This will be tested through PAM measurements on both suspended material and settled floc. Again, the floc technology assumes that the MPN-CS mesh is thin and will not impede zooplankton mobility without any off-target implications.

As stated earlier, we do note a disadvantage of the MPN-CS technology is that the material will break down when in direct contact with hydrogen peroxide. This is due to the generation of hydroxyl radicals through the Fenton reaction which oxidizes the TA and breaks down metal coordination. In later iterations, we will utilize a two-step approach of introducing solid, slow-release algaecides such as CaO₂ to presettled flocs on the benthic layer. A second disadvantage is the potential that Fe(III) will be a nutrient for algae. This is the reason to use Mg(II) as another coordinating metal in MPN formation.

The compositions and methods of the appended claims are not limited in scope by the specific compositions methods described herein, which are intended as illustrations of a few aspects of the claims and any methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise.

1. An aqueous foam precursor composition comprising:
(a) a foam-forming agent;
(b) an algicide; and
(c) optionally water.

2. (canceled)

3. The composition of claim 1, wherein the water is present in an amount of from 5% by weight to 40% by weight, based on the total weight of the aqueous foam precursor composition.

4. The composition of claim 1, wherein the water is present in an amount of from 60% by weight to 98% by weight, based on the total weight of the aqueous foam precursor composition.

5. The composition of claim 1, wherein the foam-forming agent comprises one or more surfactants.

6. The composition of claim 5, wherein the one or more surfactants comprise one or more non-ionic surfactants chosen from an alkyl polyglycoside, a polysorbate chosen from polysorbate 20 (polyoxyethylene (20) sorbitan monolaurate), polysorbate 40 (polyoxyethylene (20) sorbitan monopalmitate), polysorbate 60 (polyoxyethylene (20) sorbitan monostearate), and polysorbate 80 (polyoxyethylene (20) sorbitan monooleate), or a combination thereof.

7. (canceled)

8. (canceled)

9. The composition of claim 5, wherein the one or more surfactants comprise one or more anionic surfactants chosen from sodium lauryl sulfate (SLS), sodium cocoyl isethionate (SCI), potassium lauryl sulfate, or a combination thereof.

10. (canceled)

11. (canceled)

12. The composition of claim 5, wherein the one or more surfactants comprise a glycoside saponin chosen from a glycoside saponin extracted from Quillaja saponaria, a glycoside saponin extracted from soapwort (Saponaria officinalis), a glycoside saponin extracted from senega root (Polygala senega), a glycoside saponin extracted from sarsaparilla (Smilax ornata), or a combination thereof.

13. (canceled)

14. (canceled)

15. (canceled)

16. The composition of claim 1, wherein the foam-forming agent is present in an amount of from 0.1% by weight to 25% by weight, based on the total weight of the aqueous foam precursor composition.

17. The composition of claim 1, wherein the algicide comprises an oxidant.

18. The composition of claim 1, wherein the algicide comprises a hypochlorite salt, hydrogen peroxide, a peroxide-based compound, a peroxide-releasing compound, or a combination thereof.

19. (canceled)

20. The composition of claim 1, wherein the algicide comprises a polyphenol, curcumin, a tannin chosen from gallic acid or ellagic acid, or a combination thereof.

21. (canceled)

22. (canceled)

23. The composition of claim 1, wherein the algicide is present in an amount of from 0.1% by weight to 25% by weight, based on the total weight of the aqueous foam precursor composition.

24. The composition of claim 1, wherein the aqueous foam precursor composition further comprises one or more additional components chosen from a flocculant, a sorbent, a viscosity-modifying polymer, a foam stabilizer, a pH modifying agent (e.g., an acid, an alkali agent, or a combination thereof), a chelating agent (e.g., EDTA or a salt thereof), a biocide, a colorant, a co-solvent, or any combination thereof.

25. The composition of claim 24, wherein the aqueous foam precursor composition further comprises a flocculant.

26. (canceled)

27. (canceled)

28. (canceled)

29. The composition of claim 25, wherein the flocculant comprises a monomeric or polymeric aluminum salt and a polybasic organic carboxylic acid in a molar ratio of aluminum ion to carboxylic acid of from 0.5:1 to 50:1 (e.g., from 2:1 to 10:1).

30. (canceled)

31. (canceled)

32. (canceled)

33. (canceled)

34. The composition of claim 25, wherein the flocculant comprises a metal phenolic network (MPN).

35-44. (canceled)

45. An aqueous foam precursor composition comprising:
(a) a foam-forming agent;
(b) a flocculant; and
(c) optionally water.

46-83. (canceled)

84. A foamable composition comprising the aqueous foam precursor composition defined by claim 1 and a liquid propellant or a compressed gas propellant.

85. An aqueous-based foam comprising the aqueous foam precursor composition of claim 1 and an expansion gas.

86. (canceled)

87. (canceled)

88. (canceled)

89. A method for mitigating inhibiting, and/or eliminating phytoplankton growth in a waterbody, the method comprising
applying the foam of claim 1 to the waterbody.

90-100. (canceled)
